(19) United States
(12) Patent Application Publication
(10) Pub. No.: US 2010/0031158 A1
(43) Pub. Date: Feb. 4, 2010

(54) DATA PROCESSING DEVICE, COMPUTER PROGRAM, DATA STORAGE MEDIUM

(76) Inventors: Norikazu Takashima, Tokyo (JP); Miwa Kaneko, Tokyo (JP); Hiroshi Watanabe, Tokyo (JP)

Correspondence Address: BIRCH STEWART KOLASCH & BIRCH, PO BOX 747, FALLS CHURCH, VA, 22040-0747, US

(21) Appl. No.: 12/529,949

(22) PCT Filed: Mar. 4, 2008
(86) PCT No.: PCT/JP2008/000432

§ 371 Date: Sep. 4, 2009

(30) Foreign Application Priority Data
Mar. 5, 2007 (JP) 2007-053719
Mar. 5, 2007 (JP) 2007-053726

(51) Int. Cl. G06F 3/048; G06F 17/30

(52) U.S. Cl. 715/738; 715/765; 707/10; 707/E17.01

(57) ABSTRACT

When unit images UP output for display on a screen of a display device 801 are arranged by a layout operation effected through an input device 802, occupied dimension in the lateral direction for frame units corresponding to the layout are calculated and output for display. Accordingly, for an exemplary case of newly introducing a unit system formed based on an arbitrary combination of a plurality of types of frame units vertically engaged and laterally arranged, the layout of the frame units can readily be examined, and also the lateral dimension of thus-arranged frame units can readily be confirmed. A data processing device, configured to assist introduction of the unit system formed based on an arbitrary combination of a plurality of types of unit components, is provided.

### TECHNICAL FIELD

The present invention relates to a data processing device used for assisting introduction of a unit system formed based on an arbitrary combination of a plurality of types of unit components vertically engaged and laterally arranged; a data processing device providing a web site used for assisting introduction of a commodity display system to a user terminal device via the Internet; a computer program utilized at the data processing devices; and a data storage medium storing the computer program.

### BACKGROUND ART

At present, cigarette packs are displayed as a commodity and sold at shops such as so-called convenience stores. The “cigarette pack” mentioned herein refers to a commodity having a plurality of individual cigarettes to be smoked enclosed in a rectangular solid package.

Therefore, the commodity display system for displaying cigarette packs is typically composed of a plurality of magazine units and one system frame. Each magazine unit is typically made of a colorless clear resin, and formed into an open-top box shape oblong in the depth-wise direction. Each magazine unit, keeping the cigarette packs upright therein, is accommodated from the top while arranging them in the depth-wise direction.

The system frame holds the plurality of magazine units while arranging them in the vertical and lateral directions. In this way, the conventional commodity display system can display the cigarette packs in a vertically and laterally arranged manner.

Construction of an attractive sales floor is an important factor in view of promoting sales of commodities such as cigarette packs. Among various factors necessarily taken into consideration for constructing the sales floor, the size of the location where commodities are to be displayed is key.

Conventionally, sales floors for commodities have mainly resided on broad floors such as those in shopping malls, large volume sales stores and so forth. Recent changes in marketing style, however, have allowed for a large growth of narrow-and-small sales floors such as those in convenience stores.

In this sort of narrow-and-small sales floor, the most important theme of marketing strategies is how to bring about maximum appeal to the customers with limited space. However, conventionally, there has not been sufficient evaluation of the construction of sale floors which are highly appealing to the customers in this sort of narrow-and-small sales floor. Moreover, most commodity display systems introduced into shops are fixed, allowing only limited strategies for constructing sales floors.

In particular, for narrow-and-small shops such as convenience stores, the commodity display systems have rarely been developed from the viewpoint of customer appeal and contributing to the sales floor organization. This is because it has been necessary to ensure sales spaces for installing the commodity display systems so as to complete installation of the system within a short time.

[Patent Document 1] Japanese Laid-Open Patent Publication No. 2004-151955

### DISCLOSURE OF THE INVENTION

In order to solve the above-described subjects, the present applicant previously invented a unit-structured commodity display system filed as Japanese Patent Application No. 2006-266625. In this commodity display system, a plurality of types of unit components are arbitrarily combined, vertically engaged, and laterally arranged.

Therefore, the commodity display system can readily be transported and rapidly installed, even at narrow-and-small shops. In addition, highly appealing sales floors can be produced, by virtue of its large flexibility in terms of location of installation and cigarette pack display style. The commodity display system can therefore be contribute to the organization of ideal sales floors.

As described in the above, the commodity display system disclosed in Japanese Patent Application No. 2006-266625 allows various combinations of a plurality of types of unit components, for the purpose of realizing ideal organization of sales floors. When this sort of commodity display system is introduced into a shop, a worker can simply procure desired unit components, taking the installation space and workability into consideration. In other words, it may be necessary for the worker to determine the unit components to be procured, taking the installation space and workability into consideration.

However, there can be an enormous number of combinations of the unit components, because of too large a degree of freedom in the above-described commodity display system. Accordingly, the worker in the shop into which the commodity display system is newly planned to be introduced may encounter great difficulty in making decisions regarding optimum combinations of the unit components.

In addition, the occupied dimension of the above-described commodity display system can vary widely because the types and the number of the unit components can be freely varied. As a matter of course, the shop has to also consider the occupied dimension of introduction of a new commodity display system.

In other words, the worker of the shop, into which the commodity display system is planned to be newly introduced, is asked to examine various combinations of the unit components, while considering the occupied dimension. As a consequence, the worker may encounter a still larger difficulty in making a decision regarding the optimum combination of the unit components.

Note that the commodity display system unnecessarily huge in the vertical direction may increase danger in case of overturning, and may degrade the handlability such as preventing the worker's hand from reaching the topmost. Meanwhile, the above-described commodity display system may be configured to have a variety of outer dimensions, depending on combinations of the unit components.

The above-described commodity display system may, however, be configured to have a vertical dimension which is dangerous, or causative of extremely poor handlability, due to a high degree of freedom in the structure. Accordingly, it may be essential for the commodity display system to be preliminarily simulated in the vertical dimension, for the purpose of ensuring safety and handlability.

Narrow-and-small shops such as convenient stores require commodity display systems capable of ensuring best use of narrow spaces for installation. On the other hand, the large suburban shops on the premise of customers coming by cars may otherwise require large commodity display systems.

The vertical dimensions of the spaces for installing the commodity display systems do not differ by shops in general, with two options of installation on the sales counter and installation on the sales floor.

However, the lateral dimensions of the spaces for installing the commodity display systems largely differ by shops as described in the above. In other words, it may be essential, for the commodity displays systems allowing free configuration using a variety of unit component as described in the above, to be preliminarily simulated in the lateral dimension, requirements for which may largely differ by shops.

Conventionally, typically by the above-described Patent Document 1, proposals have been made regarding techniques of simulating how to display commodities such as cigarette packs on fittings such as a system frame, aiming at ideal organization of sales floors. However, the technique disclosed in Patent Document 1 allows simulation on how to display commodities only for fitting of fixed structures.

Therefore, the technique disclosed in Patent Document 1 could not simulate any combinations of the unit components of the commodity display system widely modifiable in the structure, and could not organize an ideal sales floor.

The present invention is conceived after considering the above-described subjects, and is to provide a data processing device configured to assist introduction of a unit system formed based on an arbitrary combination of a plurality of types of unit components.

According to the present invention, there is provided a data processing device used for assisting introduction of a unit system formed based on an arbitrary combination of a plurality of types of unit components vertically engaged and laterally arranged, including:

a display device which outputs various data to be displayed on a screen;

an input device that accepts various input operations;

a data storage unit that stores unit data including unit images modeled after front geometries of each of the plurality of types of unit components on a predetermined scale of reduction, set together with at least either of the lateral and vertical occupied dimensions thereof;

an image display unit that outputs the unit images to be displayed on the screen;

an operation detection unit that detects a layout operation which is effected through the input device on the unit images output for display on the screen;

a unit layout unit that arranges the unit images output for display on the screen, corresponding to the detected layout operation;

a result calculation unit that calculates a total of the occupied dimensions corresponding to the layout of the unit images; and

a result output unit that outputs the calculated total of the occupied dimensions to be displayed on the screen.

According to the data processing device of the present invention, when the unit images output for display on the screen are arranged by a layout operation through the input device, the occupied dimensions in at least either of the lateral and vertical directions are calculated corresponding to the layout of the unit components, and output for display. As a consequence, for the case of new introduction of the unit system formed based on an arbitrary combination of a plurality of types of unit components vertically engaged and laterally arranged, the layout of the unit components may readily be examined, and also the occupied dimensions of thus-arranged unit components may readily be confirmed.

According to the present invention, there is provided also a computer program for a data processing device including a display device which outputs various data to be displayed on a screen, and an input device which accepts various input operations, and is used for assisting introduction of a unit system formed based on an arbitrary combination of a plurality of types of unit components vertically engaged and laterally arranged, the computer program allowing the data processing device to execute:

unit storage processing of storing unit data including unit images modeled after front geometries of each of the plurality of types of unit components on a predetermined scale of reduction, set together with at least either of the lateral and vertical occupied dimensions thereof;

image display processing of outputting the unit images to be displayed on the screen;

operation detection processing of detecting a layout operation effected through the input device on the unit images output for display;

unit layout processing of arranging the unit images output for display on the screen, corresponding to the detected layout operation;

result calculation processing of calculating a total of the occupied dimensions corresponding to the layout of the unit images; and

result output processing of outputting the calculated total of the occupied dimensions to be displayed on the screen.

According to the present invention, there is provided still also a data storage medium for a data processing device including a display device which outputs various data to be displayed on a screen, and an input device which accepts various input operations, and is used for assisting introduction of a unit system formed based on an arbitrary combination of a plurality of types of unit components vertically engaged and laterally arranged, the data storage medium storing a computer program which allows the data processing device to execute:

unit storage processing of storing unit data including unit images modeled after front geometries of each of the plurality of types of unit components on a predetermined scale of reduction, set together with at least either of the lateral and vertical occupied dimensions thereof;

image display processing of outputting the unit images to be displayed on the screen;

operation detection processing of detecting a layout operation effected through the input device on the unit images output for display;

unit layout processing of arranging the unit images output for display on the screen, corresponding to the detected layout operation;

result calculation processing of calculating a total of the occupied dimensions corresponding to the layout of the unit images; and

result output processing of outputting the calculated total of the occupied dimensions to be displayed on the screen.

Note that the depth-wise direction and the lateral direction, defined in the present invention in addition to the vertical direction, are merely for the convenience's sake in order to simplify explanation of relative relations of the constituents of the present invention, and by no means limit the directions relevant to manufacturing and use in embodiments of the present invention.

In addition, the individual constituents of the present invention are not necessarily independent entities, instead allowing that a plurality of constituents is formed to give a single component, that a single constituent is formed by a plurality of components, and that a certain constituent is a part of other constituent, for example.

“Storing data” in the context of the present invention means that the device of the present invention has at least a function of storing data. The present invention therefore allows not only that the device of the present invention stores data newly registered by the consumer; but also that the device stores data registered by the supplier at manufacturing and does not accept any registration of new data by the consumer after the shipment.

According to the data processing device of the present invention, for the case of new introduction of the unit system formed based on an arbitrary combination of a plurality of types of unit components vertically engaged and laterally arranged, the layout of the unit components may readily be examined, and also the occupied dimensions of thus-arranged unit components, in at least either of the lateral and vertical directions, may readily be confirmed. As a consequence, for example, a structure of the unit system making the best use of a wide variety of spaces for installation, the lateral dimensions of which may largely vary from shop to shop, may readily be simulated. Also a structure of the unit system, having the vertical dimension which is capable of exactly ensuring safety and handlability, may readily be simulated.

### BRIEF DESCRIPTION OF THE DRAWINGS

The above and other objects, features and advantages of the present invention will be more apparent from the following description of certain preferred embodiments taken in conjunction with the accompanying drawings.

FIG. 1 A schematic drawing illustrating a logical structure of a data processing device according to an embodiment of the present invention.

FIG. 2 A block diagram illustrating a physical structure of the data processing device.

FIG. 3 A schematic drawing illustrating a displayed image on a screen of a display device of the data processing device.

FIG. 4 A perspective view illustrating an appearance of a cigarette display system as the unit system.

FIG. 5 An exploded perspective view illustrating a structure of a main portion of the cigarette display system.

FIG. 6 A perspective view illustrating an appearance of the cigarette display system adopting stocker units.

FIG. 7 An exploded perspective view illustrating a mesh unit of the cigarette display system.

FIG. 8 Schematic drawings illustrating four types of unit image.

FIG. 9 Schematic drawings illustrating two further types of unit image.

FIG. 10 Schematic drawings illustrating two still further types of unit image.

FIG. 11 Schematic drawings illustrating four further types of unit image.

FIG. 12 Schematic drawings illustrating two still further types of unit image.

FIG. 13 A schematic drawing illustrating a sales counter image.

FIG. 14 A schematic drawing illustrating a person image.

FIG. 15 A schematic drawing illustrating a logical structure of a computer program.

FIG. 16 A flow chart illustrating the former half of a processing operation of the data processing device.

FIG. 17 A flow chart illustrating the latter half.

FIG. 18 A perspective view illustrating an appearance of another cigarette display system.

FIG. 19 An exploded perspective view illustrating a structure of a main portion of the cigarette display system.

FIG. 20 An exploded perspective view illustrating still another cigarette display system.

FIG. 21 A schematic drawing illustrating a logical structure of still another data processing device.

### BEST MODES FOR CARRYING OUT THE INVENTION

One embodiment of the present invention will be explained referring to the attached drawings. A data processing device 800 of this embodiment, detailed later, is used for assisting introduction of a cigarette display system 1000 which is a unit system formed based on an arbitrary combination of a plurality of types of frame units 300 as the unit components vertically engaged and laterally arranged.

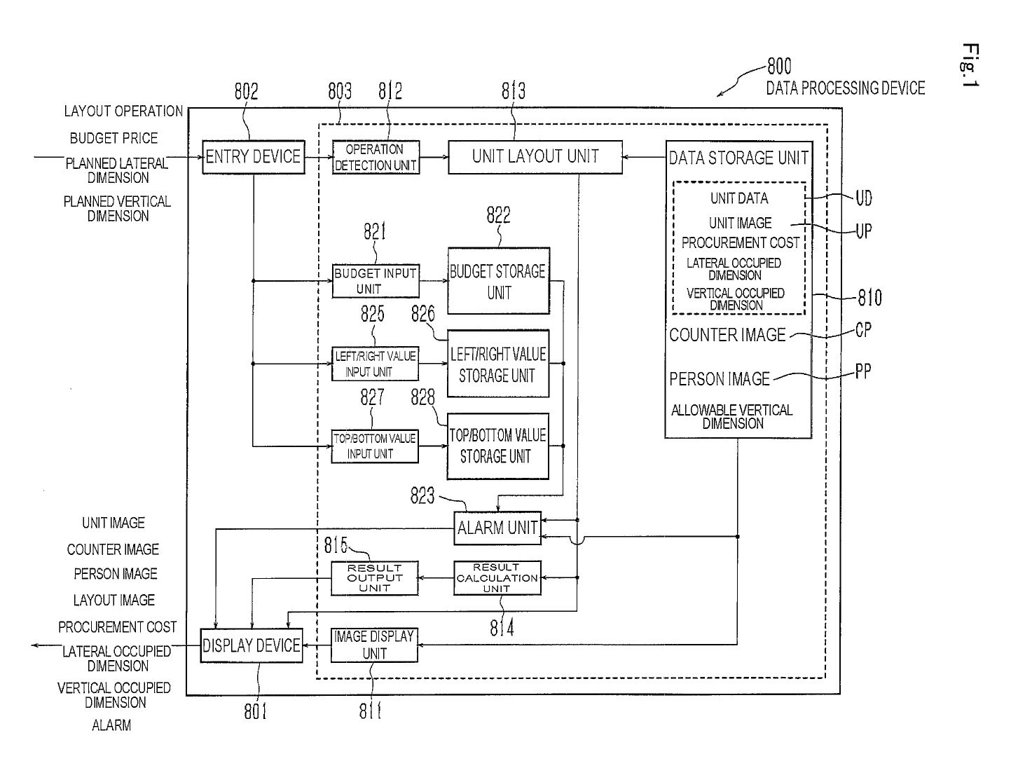

As illustrated in FIG. 1, the data processing device 800 has, as the hardware, a display device 801 outputting various data to be displayed on a screen; an input device 802 accepting various input operations; a computer unit 803 executing various types of data processing, and so forth.

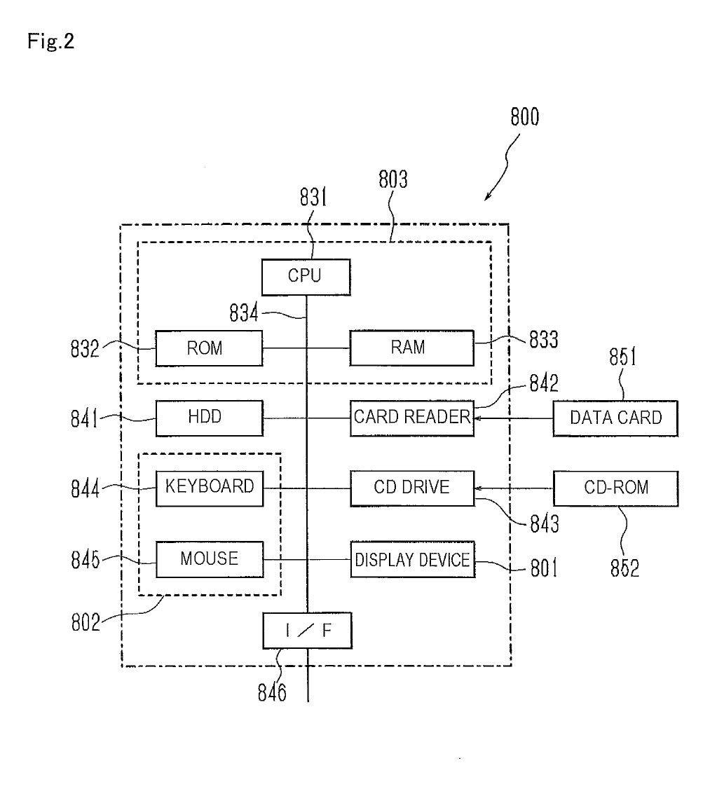

For more details, as illustrated in FIG. 2, the computer unit 803 has a CPU (Central Processing Unit) 831 executing various types of data processing, a ROM (Read Only Memory) 832 storing various data in a fixed manner, a RAM (Random Access Memory) 833 temporarily storing various data, and so forth, all of which are connected through a bus line 834 (not illustrated).

The bus line 834 is further connected to hardware including a HDD (Hard Disc Drive) 841 storing large volume of various data, a card reader 842 allowing thereon loading and unloading of a data card 851, a CD drive 843 allowing loading and unloading of a CD (Compact Disc)-ROM 852 thereon, a keyboard 844 and a mouse 845 as an input device 802, a display device 801 typically composed of an LCD (Liquid Crystal Display), and an I/F (Interface) unit 846.

In the data processing device 800 of this embodiment, the ROM 832, the RAM 833, the HDD 841, the removable data card 851, the removable CD-ROM 852, and so forth correspond to the data storage medium, wherein at least one of which stores various computer programs 860 for the CPU 831, as detailed later.

The data processing device 800 executes various types of data processing, such as image display by the display device 801, corresponding to the computer program 860, data entered through the input device 802 and so forth.

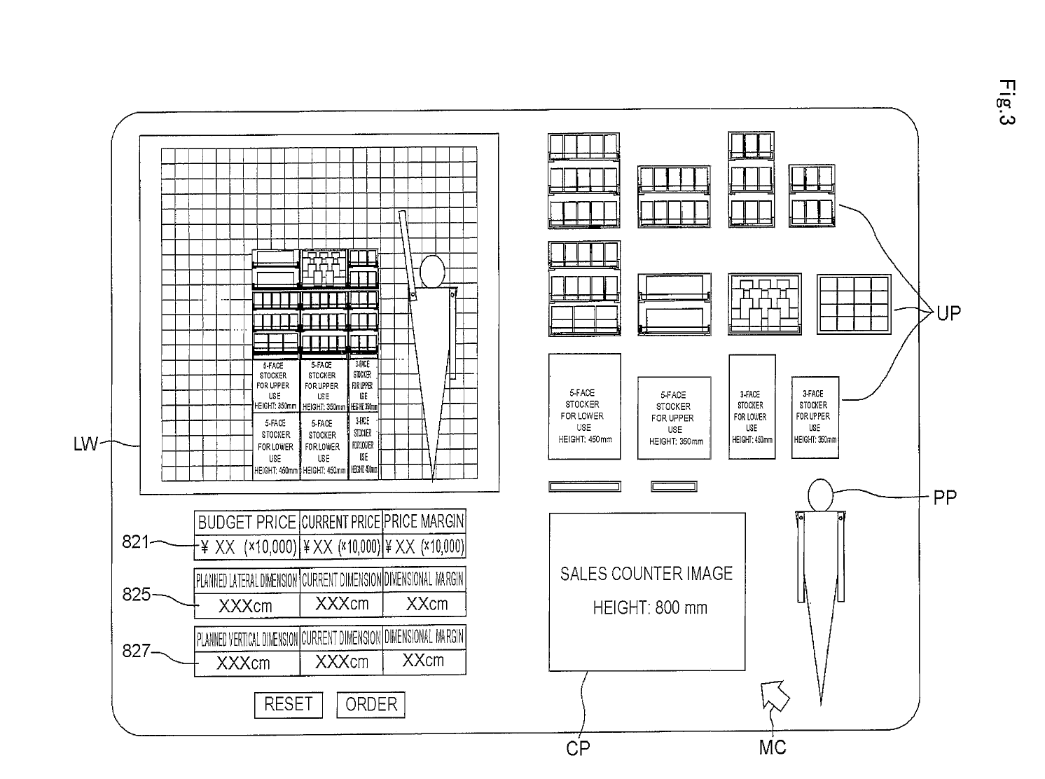

Accordingly, the data processing device 800 logically has a data storage unit 810 which stores unit data UD which includes unit images UP modeled after front geometries of each of the plurality of types of the frame unit 300 on a predetermined scale of reduction, set together with occupied dimensions in the lateral direction; an image display unit 811 which outputs the unit images UP to be displayed on the screen as illustrated in FIG. 3; an operation detection unit 812 which detects a layout operation which is effected through the input device 802 on the unit images UP output for display; a unit layout unit 813 which arranges the unit images UP output for display on the screen, corresponding to a detected layout operation; a result calculation unit 814 which calculates a total of the occupied dimensions corresponding to the layout of the unit images UP; and a result output unit 815 which outputs the thus-calculated total of the occupied dimensions to be displayed on the screen.

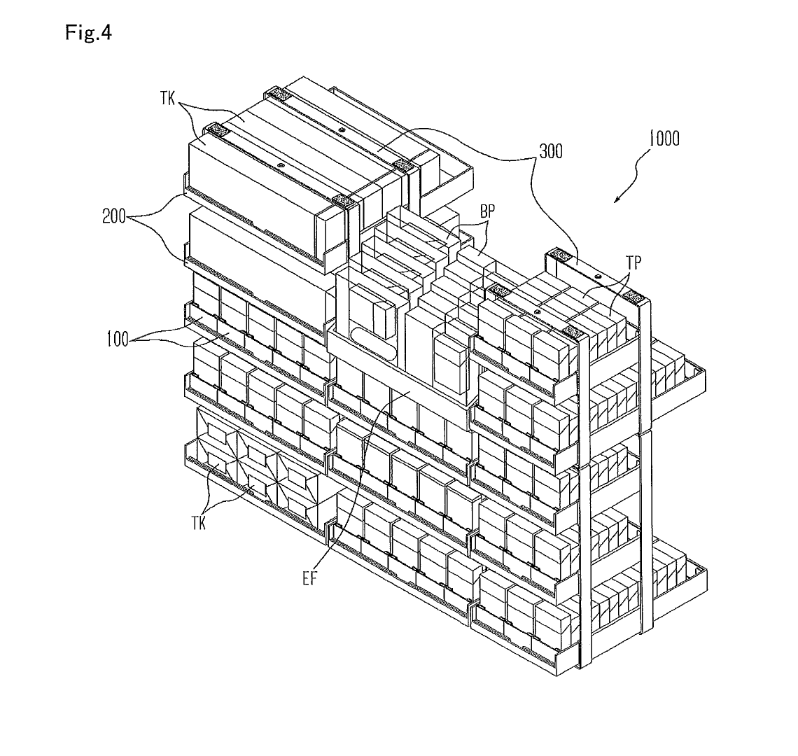

More specifically, the cigarette display system 1000, for which a layout of the frame units 300 and the occupied dimension are simulated using the data processing device 800 of this embodiment, is configured as illustrated in FIG. 4 to have a plurality of magazine units 100 each of which are formed into a depth-wisely oblong, open-top box so as to hold a plurality of cigarette packs TP arranged therein in the depth-wise direction; a plurality of tray units 200 each of which being formed into an open-top box so as to hold the plurality of magazine units 100 arranged thereon in the lateral direction in a freely replaceable manner; a plurality of frame units 300 formed into an open-front box so as to hold the plurality of tray units 200 arranged therein in a freely detachable manner while keeping them distant from each other in the vertical direction; and a vertical engagement mechanism which engages the plurality of frame units 300 in the vertical direction.

The cigarette display system 1000 displays cigarette packs TP as commodities, cigarette cartons TK each of which being a commodity containing a plurality of cigarette packs TP packaged therein, box packs BP each of which being a commodity containing a cigarette pack TP packaged together with some novelty goods, and so forth. The box packs BP are typically supplied to the shops together with simple fittings EF made of cardboard.

At present, the cigarette packs TP are formed into rectangular solids having the depth-wise and lateral dimensions generally in common, while allowing some difference in the vertical dimension. In this embodiment, the largest surfaces of the cigarette pack TP are defined as the front surface and the rear surface, and the smallest surfaces are defined as the top surface and the bottom surface.

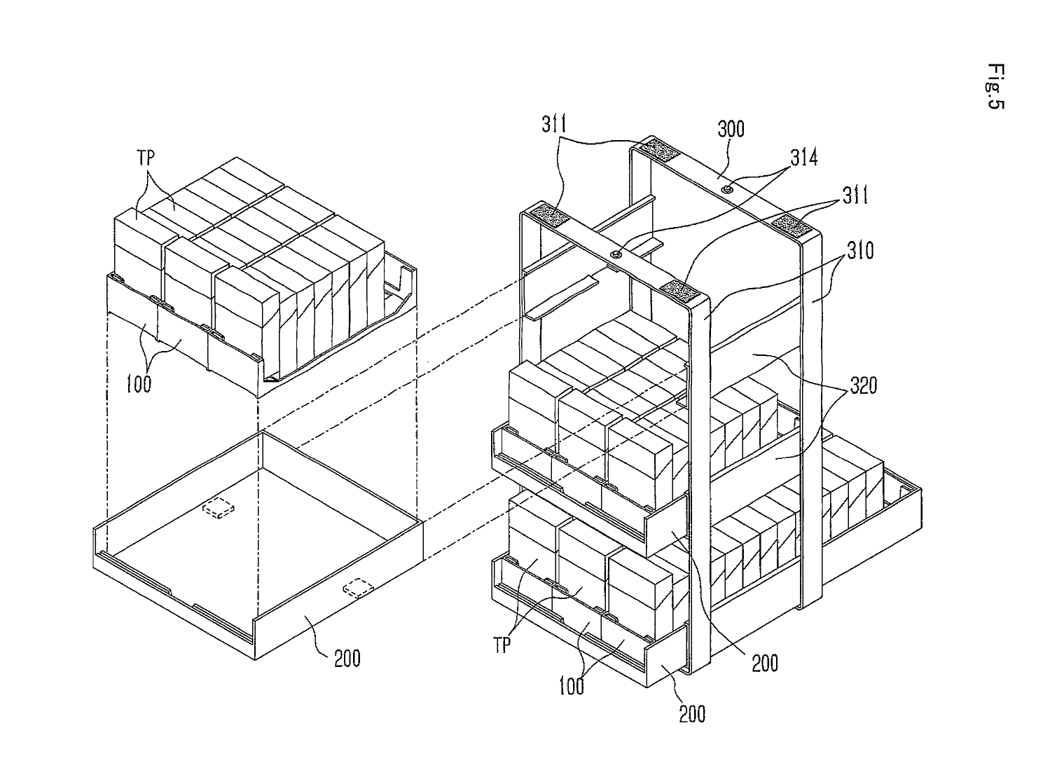

General cigarette pack TP has a brand name and so forth printed on the front surface (and rear surface). Therefore, the cigarette packs TP may preferably be displayed in an appropriate state while keeping the front surfaces thereof facing towards the front. Each magazine unit 100 accommodates a plurality of cigarette packs TP arranged in the depth-wise direction, while keeping each pack in the appropriate direction as described in the above, as illustrated in FIG. 5.

Also the tray unit 200 is formed into an open-top box using a colorless clear resin. In each tray unit 200, a plurality of magazine units 100 are accommodated while being arranged in the lateral direction.

Note that, in the cigarette display system 1000 of this embodiment, there are wide tray units 200 capable of accommodating five magazine units 100 and narrow tray units 200 capable of accommodating three magazine units 100, as illustrated in FIG. 4.

The frame unit 300 is composed of a pair of main frames 310 and a plurality of support frames 320, as illustrated in FIG. 5. Each main frame 310 is composed of a metal plate bent so as to give a rectangular frame geometry in the front view, and the pair of which are arranged in the depth-wise direction.

Each support frame 320 is made of a metal plate formed into a thin oblong rail extended in the depth-wise direction so as to support the tray unit 200, a plurality of which are arranged in the vertical direction and joined to the inner surfaces of the pair of main frames 310.

The tray units 200 herein are available in two types different in the lateral dimension, as described in the above. Therefore in the cigarette display system 1000 of this embodiment, there are the frame unit 300 holding three wide tray units 200, the frame unit 300 holding two wide tray units 200, the frame unit 300 holding three narrow tray units 200, and the frame unit 300 holding two narrow tray units 200, as illustrated in FIG. 4.

In the frame unit 300, the main frames 310 are attached with surface fasteners 311 which serve as the vertical engagement mechanism, on the top surfaces and bottom surfaces thereof on both end portions. The main frames 310 are provided with frame through-holes (not illustrated) which serve as recesses of the frame, at the individual centers of the bottom surfaces thereof. The main frames 310 are provided also with projection components 314 which serve as projections of the frame, at the individual centers of the top surfaces thereof.

Accordingly, in the cigarette display system 1000 of this embodiment, a plurality of frame units 300 having the same width, when vertically arranged, can be engaged with the aid of the surface fasteners 311, as illustrated in FIG. 4. At the same time, the frame through-holes and the projection components 314 are engaged.

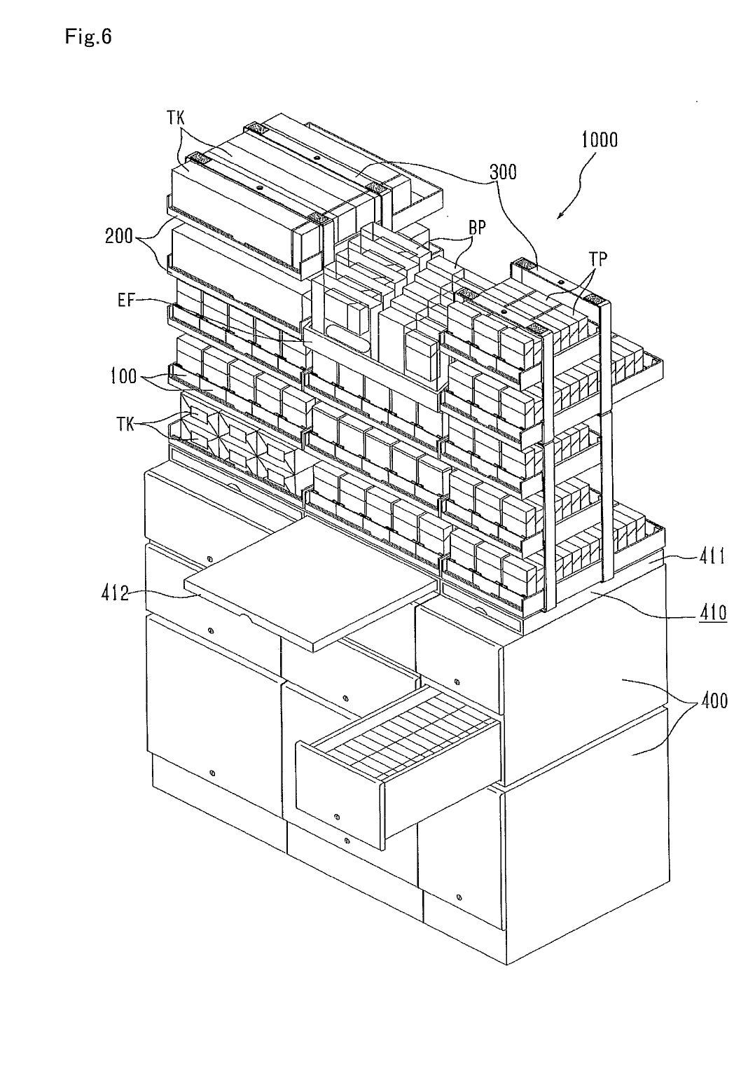

The above-described cigarette display system 1000 is generally installed over the sales counter (not illustrated) of a shop. Meanwhile, the cigarette display system 1000 additionally has stocker units 400 and table units 410, as illustrated in FIG. 6, for the convenience of installation at locations having no sales counter.

Each stocker unit 400 is formed into a box shape having a flat surface at least on the top, and can freely be opened and closed from the front. Each table unit 410 is formed into a vertically-flattened box shape having a flat top surface.

Each table unit 410 is configured to have a unit box 411 and table components 412 housed therein in a freely slidable manner in the depth-wise direction. The table component 412 can therefore be drawn out to the front, for the convenience of operability.

Since the frame units 300 are available in two types of lateral dimension as described in the above, the stocker units 400 and the table units 410 are also available in two types of lateral dimension corresponding to the frame units 300. In this way, the stocker units 400 and the table units 410 can also be combined corresponding to the frame units 300 to be adopted.

Since the tray units 200 are also available in two types of depth-wise length, so that the stocker units 400 and the table units 410 are formed to have a depth-wise length corresponding to the tray unit 200 having the largest depth-wise length.

Accordingly, whichever types of tray units 200 are used, the tray units 200 will not project out from the stocker units 400. By using the above-described stocker units 400, the cigarette display system 1000 can appropriately be installed, even at places having no sales counter (not illustrated).

Therefore, in the data processing device 800 which simulates the cigarette display system 1000 configured as described in the above, the data storage unit 810 stores unit images UP modeled after the display style of cigarette packs TP on the basis of the individual types of the frame unit 300.

Now, at least a part of the plurality of types of frame units 300 is designated with a plurality of display styles. Accordingly, the data storage unit 810 stores a plurality of types of unit images UP modeled after a plurality of types of display styles.

For more details, basically in the cigarette display system 1000, the magazine units 100 are loaded on the tray units 200 loaded on the frame unit 300, and the cigarette packs TP are accommodated in the magazine units 100 as illustrated in FIG. 4 to FIG. 6.

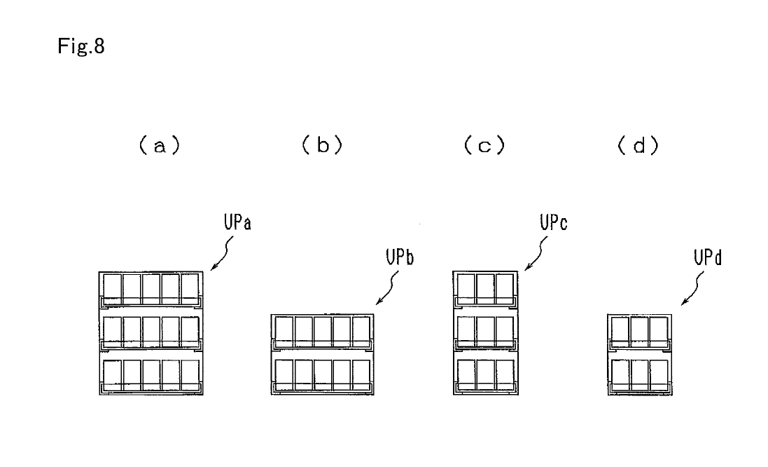

Accordingly, the unit images UP modeled after the front geometries of the frame units 300 are set to the individual unit data UD while containing, as illustrated in FIG. 8, a unit image UPa representing a state of use having the tray units 200 vertically loaded in three layers, each tray unit 200 having the cigarette packs TP laterally arranged in five columns using the magazine units 100; a unit image UPb representing a state of use having the tray units 200 vertically loaded in two layers, each tray unit 200 having the cigarette packs TP laterally arranged in five columns using the magazine units 100; a unit image UPc representing a state of use having the tray units 200 vertically loaded in three layers, each tray unit 200 having the cigarette packs TP laterally arranged in three columns using the magazine units 100; and a unit image UPd representing a state of use having the tray units 200 vertically loaded in two layers, each tray unit 200 having the cigarette packs TP laterally arranged in three columns using the magazine units 100.

Besides the style of accommodation of the cigarette packs TP in the magazine units 100 loaded on the frame units 300 with the aid of the tray units 200 as described in the above, the cigarette display system 1000 may also accommodate the cigarette cartons TK in the tray units 200 loaded on the frame units 300, while aligning the longitudinal direction of the cartons in the depth-wise direction or in the lateral direction, as illustrated in FIG. 4 to FIG. 6. In other words, the cigarette display system 1000 allows several styles of use of the frame units 300.

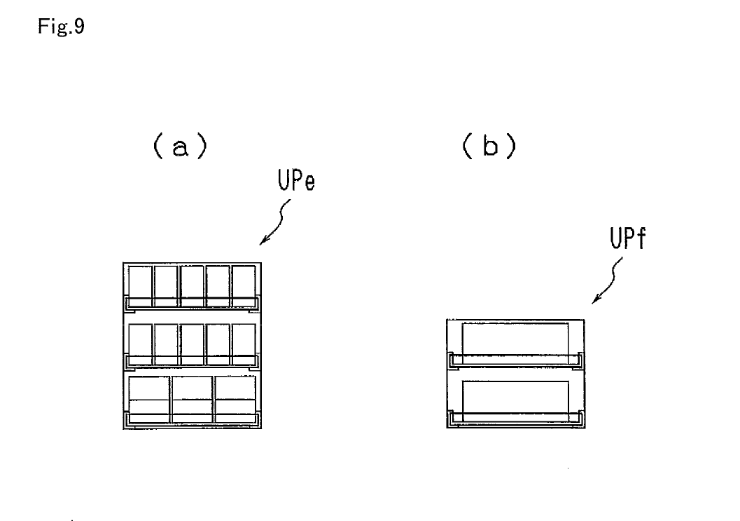

Therefore in the data processing device 800 of this embodiment, also a plurality of types of unit images UPe, UPf and so forth, given with graphics correspondent to the plurality of styles of use as illustrated in FIG. 8 and FIG. 9, are respectively set to the corresponding unit data UD.

In the cigarette display system 1000, simple fittings EF for carrying box packs BP, for example, can also be directly placed on the frame units 300 or the tray units 200, as illustrated in FIG. 4 and FIG. 6.

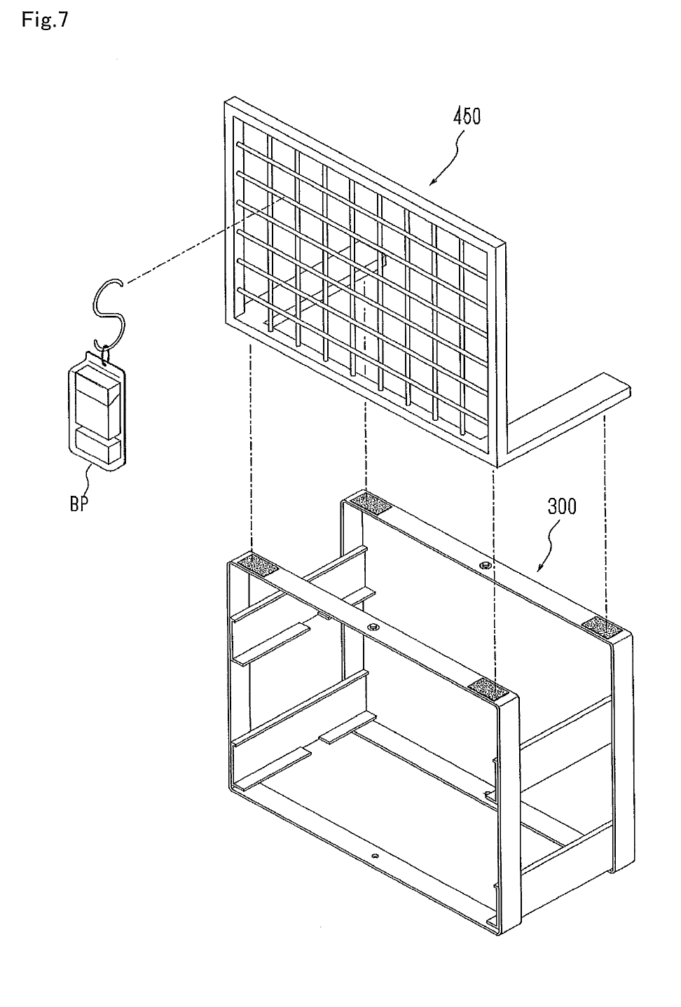

Alternatively, in the cigarette display system 1000, the box packs BP and so forth may be displayed using a mesh unit 450 freely attachable and detachable to and from the frame unit 300, as illustrated in FIG. 7.

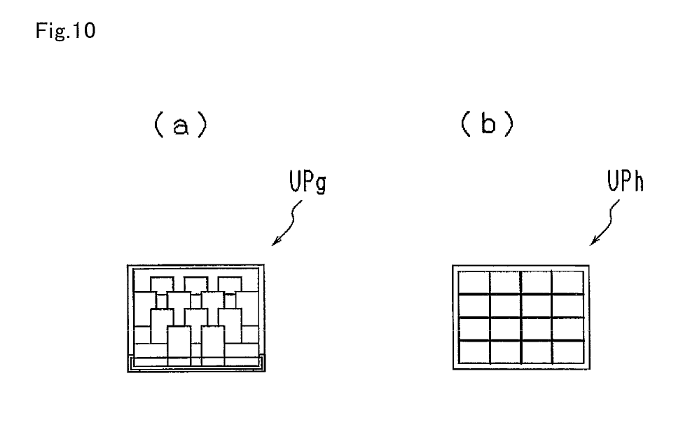

Therefore, in the data processing device 800 of this embodiment, a unit image UPg modeled after the above-described simple fitting EF as illustrated in FIG. 10(a), and a unit image UPh modeled after the mesh unit 450 as illustrated in FIG. 10(b) are also respectively set to the corresponding unit data UD.

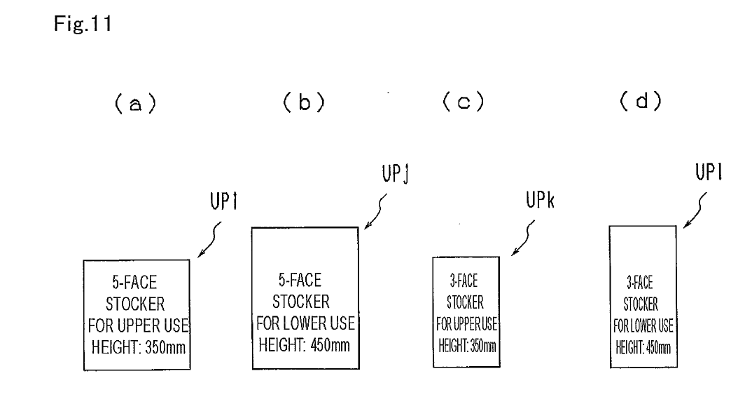

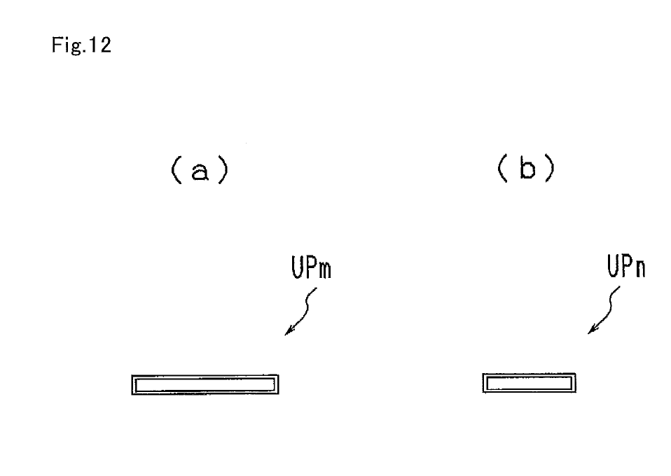

In addition, a plurality of unit images UP modeled after the front geometry of the stocker unit 400 as illustrated in FIG. 11, and the unit images UP of a plurality of table units 410 modeled after the front geometry of the table units 410 as illustrated in FIG. 12, are also respectively set to the corresponding unit data UD.

Also the stocker units 400 are available in four types based on combinations of two types of lateral dimension and two types of vertical dimension. Accordingly, the unit images UP of the stocker units 400 also appear as unit images UPi to UPl based on combinations of two types of lateral dimension and two types vertical dimension, as illustrated in FIG. 11.

Similarly, since the table units 410 are available in two types of lateral dimension, so that the unit images UP of the table units 410 also appear as unit images UPm and UPn having two types of lateral dimension, as illustrated in FIG. 12.

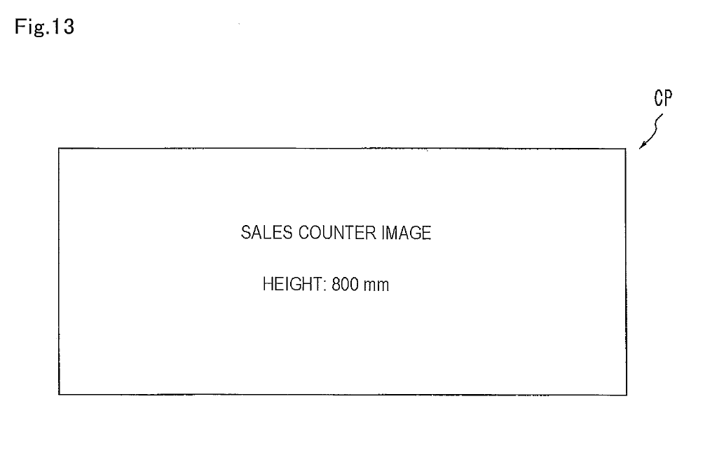

Alternatively, the cigarette display system 1000 can also be installed over the sales counter (not illustrated) of a shop, as described in the above. The data storage unit 810 therefore also stores a sales counter image CP modeled after the front geometry of the sales counter on the same scale of reduction with the unit image UP, as illustrated in FIG. 13.

Therefore in the data processing device 800 of this embodiment, the image display unit 811 outputs the above-described various unit images UPa to UPn and the sales counter image CP to be displayed on the screen as illustrated in FIG. 3, and the unit layout unit 813 arranges the unit images UP and the sales counter image CP, corresponding to a detected layout operation.

Accordingly, the image display unit 811 outputs also a special layout window LW dedicated for allowing therein layout of the unit images UP and so forth to be displayed on the screen, and gives alongside a sample display, for example, a plurality of unit images UPa to UPn and the sales counter image CP and so forth. The layout window LW displays also a grid, each edge of which represents 10 cm, for example.

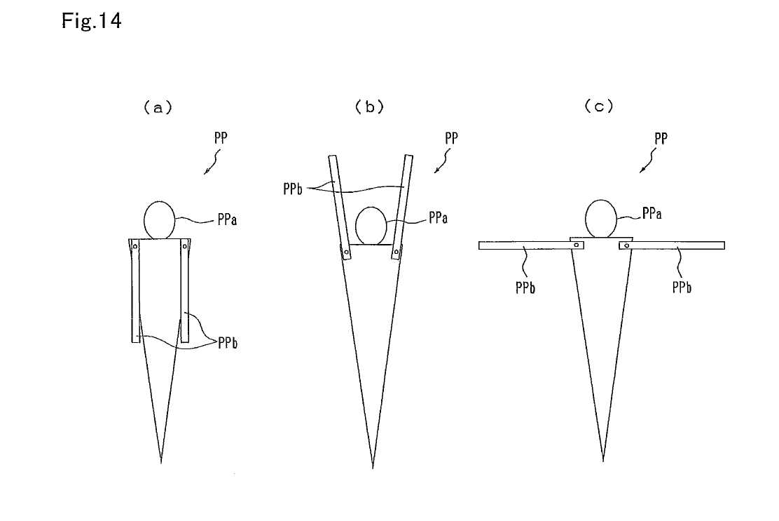

The data storage unit 810 stores also a person image, an image of a person, PP modeled after the front geometry of a person on the same scale of reduction with the unit image UP, as illustrated in FIG. 14. Accordingly, the image display unit 811 also outputs the person image PP to be displayed on the screen, as illustrated in FIG. 3.

The operation detection unit 812 therefore also detects a layout operation of the person image PP. The unit layout unit 813 arranges the person image PP in front of, or alongside of the already-arranged unit images UP, corresponding to a detected layout operation.

The above-described person image PP is composed of a main body portion PPa modeled after the head, trunk and legs of a worker, and a pair of upper limb portions PPb modeled after the upper limb of a person. The pair of upper limb portions PPb are made freely rotatable around positions corresponding to the shoulder portions of the main body portion PPa.

The operation detection unit 812 also detects an input operation for rotating the upper limb portions PPb of the person image PP being output for display. The image display unit 811 displays the person image PP, with the upper limb portions PPb of which being rotated according to an input operation.

In the data processing device 800 of this embodiment, as illustrated in FIG. 1, not only the unit images UP and lateral occupied dimensions which represent occupied dimensions in the lateral direction and vertical occupied dimension which represent occupied dimensions in the vertical direction, but also the procurement costs are set to the unit data UD stored in the above-described data storage unit 810, on the basis of the individual types of frame units 300.

Accordingly, the result calculation unit 814 respectively calculates a total of the lateral occupied dimension, a total of the vertical occupied dimension, and a current price which represents a total of the procurement costs, corresponding to the layout of the unit images UP, and the result output unit 815 outputs thus-calculated totals of the lateral occupied dimension, the vertical occupied dimension, and the current price to be displayed.

Note that the above-described vertical and lateral occupied dimensions are typically composed of the outer vertical and lateral dimensions of the frame units 300. The above-described procurement costs are typically composed of unit sale prices of the frame units 300.

The data processing device 800 of this embodiment has, in addition to the above-described components 810 to 815, a budget input unit 821 which accepts input operations of budget prices, a budget storage unit 822 which temporarily holds thus-entered budget prices, and an alarm unit 823 which outputs an alarm when thus-calculated total of procurement cost exceeds the temporarily-held budget price, as illustrated in FIG. 1.

Still further, the data processing device 800 of this embodiment has a left/right value input unit 825 which accepts input operations of the planned lateral dimensions which represent the planned dimensions in the lateral direction, a left/right value storage unit 826 which temporarily holds thus-entered planned lateral dimensions, a top/bottom value input unit 827 which accepts input operations of the planned vertical dimensions which represent the planned dimensions in the vertical direction, and a top/bottom value storage unit 828 temporarily which holds thus-entered planned vertical dimensions.

Accordingly, the alarm unit 823 also outputs an alarm when thus-calculated total occupied dimension in the lateral direction or in the vertical direction exceeds the temporarily-held planned dimension in the same direction. The output of an alarm described in the above can be executed typically so as to indicate a margin of the budget or dimension in red in a flashing manner, associated by a balloon sign containing a guidance message on the display device 801, details of which will be given later.

The data storage unit 810 also stores an allowable vertical dimension which represents an allowable dimension of the cigarette display system 1000 in the vertical direction. Accordingly, the alarm unit 823 outputs an alarm also when a thus-calculated vertical occupied dimension exceeds the preliminarily-stored allowable vertical dimension.

The above-described various input units 821, 825 and 827 are displayed on the screen as regions for entry of text data, as illustrated in FIG. 3. Accordingly, the data processing device 800 of this embodiment is also provided with a display unit for current price which represents the above-described total procurement cost, and a display unit for price margin which represents a difference between the budget price and the current price, alongside of the budget input unit 821.

Similarly, display units for the total lateral dimension and total vertical dimension, and display units for dimension margin which represents differences between the planned dimensions and the current dimensions are respectively provided alongside of the left/right value input unit 825 and the top/bottom value input unit 827.

The plurality of types of frame units 300 of the cigarette display system 1000 can yield combinations of those engageable with each other and combinations of those unengageable with each other in the vertical direction. The data storage unit 810 therefore stores unit data UD set with the combinations of those engageable with each other in the vertical direction, on the basis of the individual types of the frame units 300.

The unit layout unit 813 therefore nullifies any layout operation relevant to the combination of the unit components unengageable with each other in the vertical direction, and the alarm unit 823 outputs an alarm when a layout operation is effected on the combination of unit images UP unengageable with each other in the vertical direction.

The above-described individual sections 810—of the data processing device 800 are logically realized by the computer unit 803 executing various process operations corresponding to the computer program 860 installed thereon as described in the above.

This sort of computer program 860 is offered by a supplier of the cigarette packs TP to the shops, for example, in the form of application software stored in a data storage medium such as a CD-ROM 852 (not illustrated).

The data processing device 800 at the shop, onto which the above-described computer program 860 is installed as application software, has an OS (Operating System) preliminarily installed thereon. Therefore, the above-described individual sections 810—are actually realized by the cooperative operation of the OS and the application software.

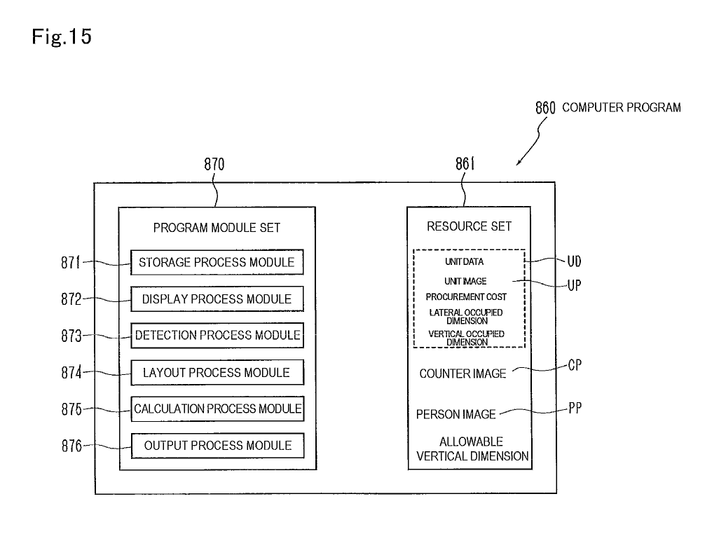

The computer program 860 of the application software is typically composed of a resource set 861 and a program module set 870, as illustrated in FIG. 15.

The resource set 861 contains various data including the unit data UD which is composed of the unit image UP, the procurement cost and so forth as described in the above; the sales counter image CP; the person image PP; allowable vertical dimension, and so forth.

The program module set 870 contains various program modules to be executed by the data processing device 800, including a storage process module 871 which allows unit storage process of the unit data UD, which is composed of unit images UP modeled after the front geometries on a predetermined scale of reduction, set together with the occupied dimensions in the lateral and vertical dimensions, the procurement costs and so forth, on the basis of the individual types of the frame units 300; a display process module 872 which allows output of the unit image UP to be displayed on the screen of the display device 801; a detection process module 873 which allows operation detection processing for detecting layout operations effected through the input device 802 on the unit images UP being output for display; a layout process module 874 which allows unit layout process for arranging the unit images UP being output for display on the screen of the display device 801, corresponding to any detected layout operation; a calculation process module 875 which allows execution of result calculation process for calculating a total of the occupied dimensions and a total of the procurement costs, corresponding to the layout of the unit images UP; and an output process module 876 which allows result output process for outputting a thus-calculated total of occupied dimensions and the total of procurement costs to be displayed on the screen.

Methods of using the data processing device 800 of this embodiment and the cigarette display system 1000 configured as described in the above will be explained below. First, the cigarette display system 1000 of this embodiment may be configured, depending on needs, by freely combining four types of frame unit 300, four types of tray unit 200, two types of magazine unit 100 and so forth.

Accordingly, the cigarette display system 1000 of this embodiment may have an appearance adapted to the installation space, so as to ensure an effective use of space. In particular, by virtue of using the narrow frame unit 300 capable of accommodating the cigarette packs TP in three columns, and the wide frame units 300 capable of accommodating the cigarette packs TP in five columns, the cigarette display system 1000 can be adapted well to the lateral dimension of the installation space.

In addition, by virtue of using the tall frame units 300 capable of holding the cigarette packs TP in three rows, and the short frame units 300 capable of holding them in two rows, the cigarette display system 1000 can be well adaptable also to the vertical dimension of the installation space.

Note that, the cigarette display system 1000 is extremely high in the degree of freedom of installation as described in the above. Shop planning to newly introduce the system is therefore recommended to thoroughly investigate the layout of the frame units 300.

Another feature is that the cigarette display system 1000 can be susceptible of free modification of the types and number of the frame units 300 adopted by the shop as described in the above. Consequently, the procurement costs of the frame units 300 necessary for newly introducing the cigarette display system 1000 may be not always the same.

It may, therefore, be preferable for the shop planning to newly introduce the cigarette display system 1000 to preliminarily simulate the layout of the frame units 300 and the procurement costs.

For this reason, when the cigarette display system 1000 is planned to be introduced into the shop, the computer program 860 allowing the computer device to function as the data processing device 800 of this embodiment is offered to the shop by the supplier of the cigarette packs TP and the cigarette display system 1000, typically in a form of the CD-ROM 852.

In this process, the worker of the shop installs the computer program 860 on his or her own computer device, and runs the computer program 860 to allow the computer device to function as the data processing device 800.

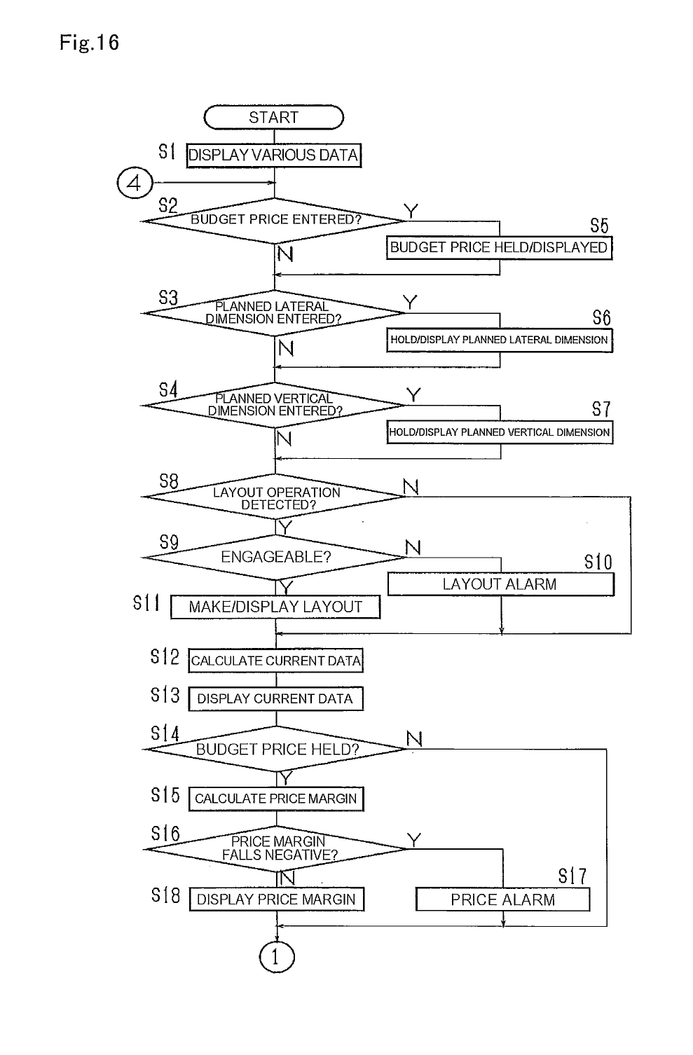

Then in the data processing device 800, the individual unit images UPa to UPn, the sales counter image CP, the person image PP, the layout window LW, the input unit 821 and display unit for the various prices, the input units 825, 827 and display unit for the various dimensions and so forth are output for display on the screen of the display device 801, as illustrated in FIG. 3 and FIG. 16 (step S1).

On the initial screen in this process, the layout window LW, the input units 821, 825, 827, display units for the prices and dimensions and so forth appear blank. Also a mouse cursor MC is output for display on the screen, as a result of cooperative operation of the above-described computer program 860 and the OS.

In this situation, if the worker makes, depending on needs, input operations of the budget price, and planned vertical and lateral dimensions through the input device 802 into the input units 821, 825, 827 (steps S2 to S4), the entry data are held and output for display in the units 821, 825, 827 (steps S5 to S7).

For example, when the shop planning to introduce the cigarette display system 1000 sets the budget price to ¥100,000, text data of “100000” is entered by an input operation to the budget input unit 821 through the input device 802, and then output for display.

When the planned lateral dimension of the installation space of the cigarette display system 1000 in the shop is 120 cm, a text data of “120” is entered by an input operation to the left/right value input unit 825, and then output for display.

Similarly, when the planned vertical dimension of the installation space of the cigarette display system 1000 in the shop is 140 cm, a text data of “140” is entered by an input operation to the top/bottom value input unit 827, and then output for display.

When the worker makes, depending on needs, a layout operation so as to place the unit images UP and the sales counter image CP in the layout window LW, via a drag-and-drop operation using the mouse cursor MC, the data processing device 800 detects the operation (step S8), and judges whether the layout operation is valid or not (step S9).

For example, as illustrated in FIG. 3, the unit images UP of the frame units 300 and the stocker units 400, and the sales counter image CP may be arranged at the lowermost portion of the layout window LW.

In addition, the unit image UP of the stocker unit 400 may be arranged right above the unit image UP of the stocker unit 400. Also the unit images UP of the table unit 410 and the frame unit 300 may be arranged right above the unit image UP of the stocker unit 400 and the sales counter image CP. The unit image UP of the frame unit 300 may be arranged right above the unit image UP of the frame unit 300.

It is, however, not permissible to arrange the sales counter image CP anywhere other than the lowermost portion. It is also not permissible to arrange the unit image UP of the stocker unit 400 right above the unit image UP of the frame unit 300.

The unit image UP of the table unit 410 cannot be arranged anywhere other than the intermediate region between the unit images UP of the sales counter image CP or the stocker units 400 and the unit image UP of the frame unit 300. The above-described limitations on the layout are set typically as attribute data, respectively to the unit data UD, the sales counter image CP and so forth.

Accordingly, if any impossible layout operation is executed by the worker (step S9), such a layout operation is ignored, and a layout alarm with a guidance message such as “Impossible layout. This unit is . . . ”, for example, is output to be alarming typically in a form of balloon (step S10).

On the other hand, when any possible layout operation is executed by the worker (step S9), a layout data is produced corresponding to the layout operation, and the sales counter image CP and the unit images UP are displayed in an arranged form in the layout window LW (step S11).

Those arranged in the layout window LW are, of course, copies of the unit images UP. Therefore, the worker depending on needs can also arrange the same unit images UP to form a multiple stack in the layout window LW.

The layout window LW is variable in the vertical and lateral dimensions, typically through an input operation again using the mouse cursor MC. The unit images UP arranged in the layout window LW are output for display on the scale of reduction corresponding to the layout window LW.

In the data processing device 800 of this embodiment, the sales counter image CP arranged as described in the above may be stretchable in the lateral direction, typically by an input operation effected through the input device 802. The sales counter image CP may therefore be made to correspond to the sales counter actually installed at the shop.

In the data processing device 800 of this embodiment, also the person image PP may be arranged in the layout window LW as illustrated in FIG. 3, through a process operation independent from the above-described layout operation of the unit images UP.

In this case, the upper limb portions PPb of the person image PP may be rotated by operation, depending on needs. Accordingly, the unit images UP may be arranged while making comparison with standard stature and working range of the worker.

Once the unit images UP are arranged in the layout window LW as described in the above, the procurement costs of unit data UD correspondent to the unit images UP are summed up to calculate a current price.

In addition, the lateral dimension and vertical dimension of the unit data UD are respectively summed up corresponding to the layout of the unit images UP, and thereby a current lateral dimension and a current vertical dimension are calculated (step S12). The current price, the current lateral dimension, and the current vertical dimension thus calculated are output for display (step S13).

For an exemplary case where the unit images UP of the frame unit 300 respectively having a unit price of ¥4,000, a lateral dimension of 35 cm and a vertical dimension of 25 cm are arranged in three rows in the lateral direction, and in six rows in the vertical direction, a text data of “72000” can be found in the display unit for the current price in adjacent to the budget input unit 821, a text data of “105” can be found in the display unit for the current lateral dimension in adjacent to the left/right value input unit 825, and a text data of “150” can be found in the display unit for the current vertical dimension adjacent to the top/bottom value input unit 827.

For the case where the budget price is entered by an input operation and temporarily held as described in the above (step S14), a price margin is calculated as a result of subtraction of the current price from the budget price (step S15).

If the price margin falls on a positive value (step S16) the price margin can be output for display as it is (step S18). On the other hand, if the price margin falls on a negative value (step S16), the price margin can typically be displayed in red in a flashing manner, associated with a balloon sign containing a guidance message such as “Budget exceeded.”, output as a budget alarm (step S17).

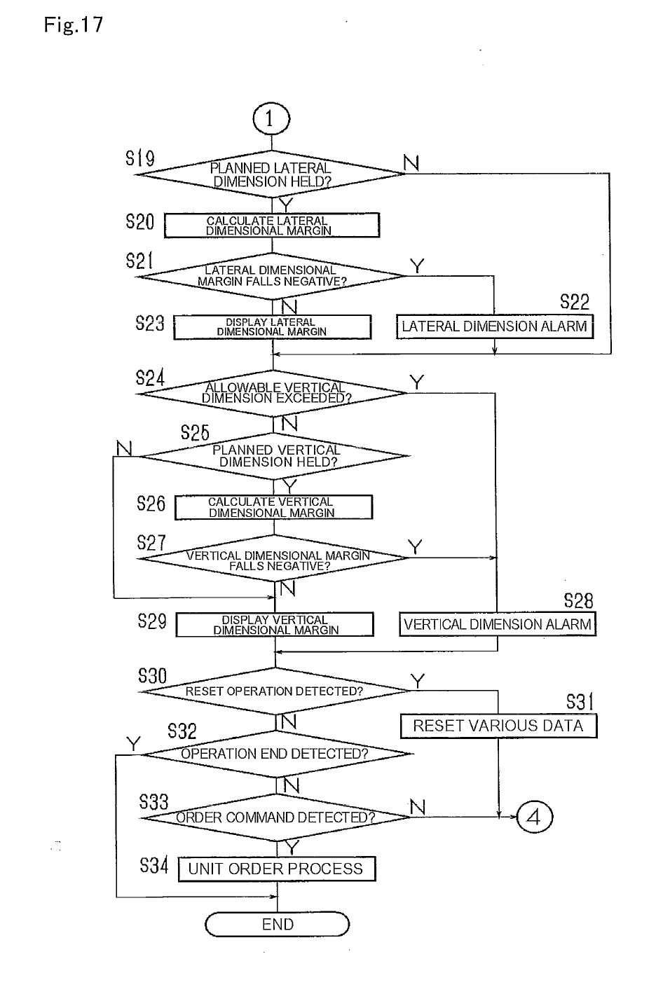

For another exemplary case, as illustrated in FIG. 17, where the planned lateral dimension is entered by an input operation and temporarily held as described in the above (step S19), a lateral dimensional margin is calculated as a result of subtraction of the current lateral dimension from the planned lateral dimension (step S20).

If the lateral dimensional margin falls on a positive value (step S21), the lateral dimensional margin can be output for display as it is (step S23). On the other hand, if the lateral dimensional margin falls on a negative value (step S21) the lateral dimensional margin can typically be displayed in red in a flashing manner, associated with a balloon sign containing a guidance message such as “Laterally oversized beyond planned value.”, output as a lateral value alarm (step S22).

The current vertical dimension is judged whether it exceeds the allowable vertical dimension (step S24), and if it is found to exceed, the current vertical dimension is displayed in red in a flashing manner, associated with a balloon sign containing a guidance message such as “Vertically oversized beyond safety range.”, output as a left/right value alarm (step S28).

On the other hand, if the current vertical dimension is not found to exceed the allowable vertical dimension (step S24), and if the planned vertical dimension is preliminarily entered by an input operation and temporarily held as described in the above (step S25), a vertical dimensional margin is calculated as a result of subtraction of the current vertical dimension from the planned vertical dimension (step S26).

If the vertical dimensional margin falls on a positive value (step S27), the vertical dimensional margin can be output for display as it is (step S29). On the other hand, if the vertical dimensional margin falls on a negative value (step S27), the vertical dimensional margin can typically be displayed in red in a flashing manner, associated with a balloon sign containing a guidance message such as “Vertically oversized beyond planned value.”, output as a vertical value alarm (step S28).

For an exemplary case where the current price is calculated as “72000”, the current lateral dimension as “105”, and the current vertical dimension as “150” by a layout operation, while the budget price is preliminarily set to “100000”, the planned lateral dimension to “120”, and the planned vertical dimension to “140” as described in the above, a price margin of “28000” and a lateral dimensional margin of “15” are output for display as positive values, whereas the vertical dimensional margin is displayed in red in flashing manner as a negative value of “−10”, associated with the alarm guidance.

Even if the alarms relevant to the price and dimension are once output for display as described in the above, it is also possible to make the alarm no longer be output (steps S12 to S29), by re-entering the budget price and the planned dimension (steps S2 to S7), or by modifying the layout of the unit images UP (steps S8 to S11), as illustrated in FIG. 16.

Even for an exemplary case where the unit images UP of the frame units 300 each having a vertical dimension of 25 cm are vertically arranged in six rows, thereby to give a current vertical dimension of “150” and a vertical dimensional margin of “−10”, while the planned vertical dimension is set to “140” as described in the above, deletion of the topmost unit image UP causes the current vertical dimension to be reduced to “125” and the vertical dimensional margin to be increased to “15”, with the alarm guidance disappearing.

If the reset icon on the screen is entered by an input operation (step S30), thus-entered budget price, thus-arranged unit images UP and so forth are reset (step S31).

The worker, who successfully confirmed the desirable layout of the unit images UP as a result of the above-described input operation, and wishes to place an order of the thus-arranged cigarette display system 1000, can make an input of an order icon on the screen, as illustrated in FIG. 3.

Then as illustrated in FIG. 17, the data processing device 800 which detected this operation (step S33) typically outputs and displays an order screen to be filled with shop information and so forth, and sends various data entered therein to the supplier of the cigarette display system 1000 via the Internet, to thereby execute the order process (step S34).

In this process, the order data sent from the shop to the supplier includes, for example, the unit data UD obtained after the layout operation, layout data composed of relative relations among a plurality of unit data UD, total price, and so forth.

The supplier who receives the above-described order data then for example makes an assembly manual corresponding to the layout data, and also makes a bill based on the total price inscribed in the order data.

The supplier then sends the frame units 300 and so forth, correspondent to the unit data UD in the order data, and the assembly manual and the bill enclosed therewith to the shop. The received frame units 300 are assembled at the shop referring to the assembly manual, and thereby the cigarette display system 1000 is installed. The shop pays the charge to the supplier, corresponding to the bill enclosed with the frame units 300.

The cigarette display system 1000 of this embodiment allows free modification of the vertical and lateral dimensions and so forth, by arbitrarily combining, at the shop, a plurality of types of the frame units 300 as described in the above, so that an ideal organization of the sales floor can be realized.

However, in other words, this asks the shop, going to use the cigarette display system 1000, to determine the layout of the frame units 300 and so forth, so as to adapt them to the vertical and lateral dimensions of the installation space. It may be necessary for the shop, going to newly introduce the cigarette display system 1000, also to consider the procurement cost, which can vary depending on the types and number of the frame unit 300 and so forth.

The cigarette display system 1000 has, however, an extremely large degree of freedom in the layout of the frame units 300 and so forth. It may, therefore, be not so easy to determine an optimum layout while taking the overall occupied dimension and the procurement cost into consideration.

With the data processing device 800 of this embodiment, it is now possible to make layout operations of the unit images UP output for display on the screen, via the input device 802 as described in the above.

The data processing device 800 of this embodiment calculates the occupied dimension of the actual cigarette display system 1000, and outputs it to be displayed, every time the layout operation of the unit images UP takes place.

Accordingly, the dimensions necessary for the installation can be confirmed in real time, while arranging the desired unit images UP by the layout operation. As a consequence, a labor typically for organizing the cigarette display system 1000, capable of making the best use of the space for installation at the shop, may be assisted in a desirable manner. In particular, since the occupied dimensions can be calculated independently in the vertical direction and in the lateral direction, so that a layout best matched to the installation space can be examined.

The cigarette display system 1000 unnecessarily huge in the vertical direction may increase danger in case of overturning, and may degrade the handlability such as preventing the worker's hand from reaching the topmost. Meanwhile, with the data processing device 800 of this embodiment, the occupied dimension in the vertical direction of the cigarette display system 1000 may be output for display in association with the layout operation effected on the unit images UP as described in the above, so that a structure of the cigarette display system 1000 configured to have the vertical dimension, which is capable of exactly ensuring safety and handlability, may readily be simulated.

In particular, the data processing device 800 of this embodiment also stores an allowable vertical dimension preliminarily determined from the viewpoint of safety, besides the planned vertical dimension freely set by the worker. Therefore, a specific dimensional alarm may be output for alarming if the current vertical dimension exceeds the allowable vertical dimension, even if the planned dimension is not exceeded.

Accordingly, the worker may be made readily and exactly recognize a safe vertical dimension of the cigarette display system 1000, and thereby the cigarette display system 1000 may be prevented from being used after being built to have a dangerous dimension.

As a consequence, the worker may confirm the dimension necessary for the installation in real time, while arranging the layout of desired unit images UP. Therefore, a structure of the cigarette display system 1000 making the best use of a space for installation, the lateral dimension of which may largely vary from shop to shop, may readily be simulated.

In the narrow-and-small shops such as convenient stores, the cigarette display system 1000 is required to make the base use of the space for installation which is narrow in the lateral direction, as described in the above. On the other hand, the cigarette display system 1000 huge in the lateral direction may otherwise be required for the large suburban shops and so forth on the premise of customers coming by cars.

The cigarette display system 1000 of this embodiment may be adaptable to requirements on the lateral dimension which differ from shop to shop as just described. With the data processing device 800 of this embodiment, the lateral dimension of the cigarette display system 1000 may preliminarily be simulated as described in the above, so that the requirements on the lateral dimension which largely differ from shop to shop may readily be settled.

In particular, the data processing device 800 of this embodiment separately calculates the occupied dimensions in the vertical direction and in the lateral direction, so that a layout optimized to the place of installation may be examined.

Also the planned vertical and lateral dimensions can be entered by the input operation at the worker's will, wherein the current vertical and lateral dimensions are output for display alongside of the planned dimensions. Moreover, the dimensional margins calculated by subtracting the current dimensions from the planned dimensions can further be output for display alongside thereof.

Accordingly, the worker can compare the occupied dimensions with the planned dimensions in real time, while arranging any desired unit images UP by the layout operation, and can thereby confirm the dimensional margins in real time.

In particular, a dimensional alarm is output when the dimensional margin falls on a negative value. The worker can therefore confirm that the current dimension exceeded the planned dimension in real time, while arranging the unit images UP by the layout operation.

Modification of the layout of the unit images UP or edition of the planned dimensions can be allowable even when the dimensional alarm remains active in this manner, and output of the dimensional alarm is cleared when the dimensional margin falls on a positive value.

Accordingly, the worker can examine the layout of the frame units 300 installable on site without causing any problems, the space necessary for installing the desired cigarette display system 1000 and so forth in real time.

In the cigarette display system 1000, a plurality of types of frame units 300 and so forth may yield combinations of those engageable with each other and combinations of those unengageable with each other in the vertical direction. Therefore, the data processing device 800 nullifies any layout operation relevant to the combination of the unit images UP unengageable with each other in the vertical direction, and outputs a layout alarm when any layout operation is performed on the combination of the unit images UP unengageable with each other in the vertical direction.

The data processing device 800 also stores allowable vertical dimensions which are preliminarily determined from the viewpoint of safety, besides the planned vertical dimension freely set by the worker. Therefore, a specialized dimensional alarm is output when the current vertical dimensions exceed the allowable vertical dimensions, even though the planned vertical dimensions are not exceeded.

Therefore, the safe vertical dimensions of the cigarette display system 1000 can readily and exactly be recognized by the worker, and thereby the cigarette display system 1000 is prevented from being used after being built up to have dangerous dimensions.

The plurality of types of frame units 300 and so forth of the cigarette display system 1000 can yield combinations of those engageable with each other and combinations of those unengageable with each other in the vertical direction. The data processing device 800 therefore nullifies any layout operation for the combinations of the unit images UP unengageable with each other in the vertical direction, and outputs a layout alarm for alarming when a layout operation is effected on the combinations of unit images UP unengageable with each other in the vertical direction.

Therefore, the combinations of the frame units 300 and so forth unengageable can readily and exactly be recognized by the worker, and thereby the cigarette display system 1000 is prevented from being used after being built up to have dangerous structure.

The cigarette display system 1000 is often installed over the top surface of the sales counter of the shop. The data processing device 800 allows the layout operation, while outputting also the sales counter image CP, modeled after the front geometry of the sales counter on the same scale of reduction with the unit images UP, to be displayed on the screen. The worker can therefore readily confirm a finished image of the cigarette display system 1000, also for the case where it is installed over the sales counter.

In particular, if the sales counter image CP is arranged together with the unit images UP by the layout operation as described in the above, the vertical dimension of the sales counter can be reflected on the vertical dimension of the cigarette display system 1000, while leaving the lateral dimension and the price not reflected thereon. Accordingly, only information which is necessary to examine can be provided to the worker, when the cigarette display system 1000 is planned to be installed over the top surface of the sales counter.

Moreover, the procurement costs of the frame units 300 correspondent to the layout is calculated and output for display. Accordingly, the layout of the frame units 300 and so forth can readily be examined by the worker, even when the cigarette display system 1000 is planned to be newly introduced, and also the procurement costs of thus-arranged frame units 300 and so forth can readily be confirmed.

The worker can therefore determine an optimum layout of the frame units 300 and so forth, taking even the overall occupied dimension and the procurement cost of the cigarette display system 1000 into consideration. As a consequence, the data processing device 800 can assist, for example, an operation for constructing an optimally-configured cigarette display system 1000 at a minimum procurement cost.

In particular, since the unit images UP are modeled after front geometries of a plurality of types of the frame units 300 and so forth, the worker can confirm a finished image of the cigarette display system 1000 in a real time by intuition.

Moreover, the data processing device 800 calculates the total procurement cost and outputs it to be displayed, every time the layout operation of the unit images UP takes place. The worker can, therefore, confirm the cost necessary for the procurement in real time, while executing the layout operation of desired unit images UP.

In particular, the data processing device 800 allows input of the budget price at the worker's will, and displays the current price alongside of the budget price. Also the price margin calculated by subtracting the current price from the budget price is displayed alongside thereof.

Accordingly, the worker can compare the procurement cost with the budget price in real time, while arranging any desired unit images UP, and can therefore confirm the price margin in real time.

In particular, when the price margin falls on a negative value, the price alarm is output for alarming. The worker can therefore confirm that the current price exceeded the budget price, in the process of layout operation of the unit images UP.

Modification of the layout of the unit images UP or edition of the budget price can be allowable even when the price alarm remains active, and output of the price alarm is cleared when the price margin falls on a positive value.

Accordingly, the worker can examine, for example, the layout of the frame units 300 within the planned budget, and the budget necessary for introducing the desired cigarette display system 1000 in real time.

In the cigarette display system 1000, display styles of the cigarette packs TP, the cigarette cartons KT and so forth are designated on the basis of the individual types of the frame units 300. The data processing device 800 allows the layout operation while outputting and displaying the unit images UP modeled after the display style. The worker can, therefore, readily and exactly confirm different display styles of the cigarette packs TP and so forth on the frame units 300 of the same dimension.

In the cigarette display system 1000, the simple fittings EF such as the box packs BP can directly be placed on the frame units 300 and the tray units 200. Also the mesh unit 450, for example, can be adoptable.

The data processing device 800 can, however, allow the layout operation while outputting and displaying also the unit images UPa to UPh having graphics of the above-described plurality of types of display styles. The worker can, therefore, readily confirm a finished image of the cigarette display system 1000, even for the case where the individual unit 450 and so forth are used.

The data processing device 800 of this embodiment allows the layout operation, while outputting and displaying also the person image PP modeled after the front geometry of a person on the same scale of reduction with the unit images UP on the screen.

The worker can, therefore, confirm also, for example, whether the vertical dimension of the cigarette display system 1000 to be configured is excessive or not, and can thereby confirm the overall dimension and so forth of the cigarette display system 1000 by intuition.

In particular, the person image PP allows rotation of the upper limb portions PPb thereof by the input operation. The worker can, therefore, readily and exactly confirm, for example, whether the vertical dimension of the cigarette display system 1000 to be configured is appropriate or not.

The person image PP has a pair of left and right upper limb portions PPb. It can therefore be possible also to confirm, for example, whether the lateral dimension of the cigarette display system 1000 to be built up is appropriate, typically by horizontally placing the left and right upper limb portions PPb of the person image PP.

Note that the present invention is not limited to this embodiment, instead allowing various modifications without departing from the spirit thereof. For example, the embodiment in the above shows an exemplary case where the cigarette display system 1000 has the frame units 300 as the unit components, and the data processing device 800 is correspondingly formed.

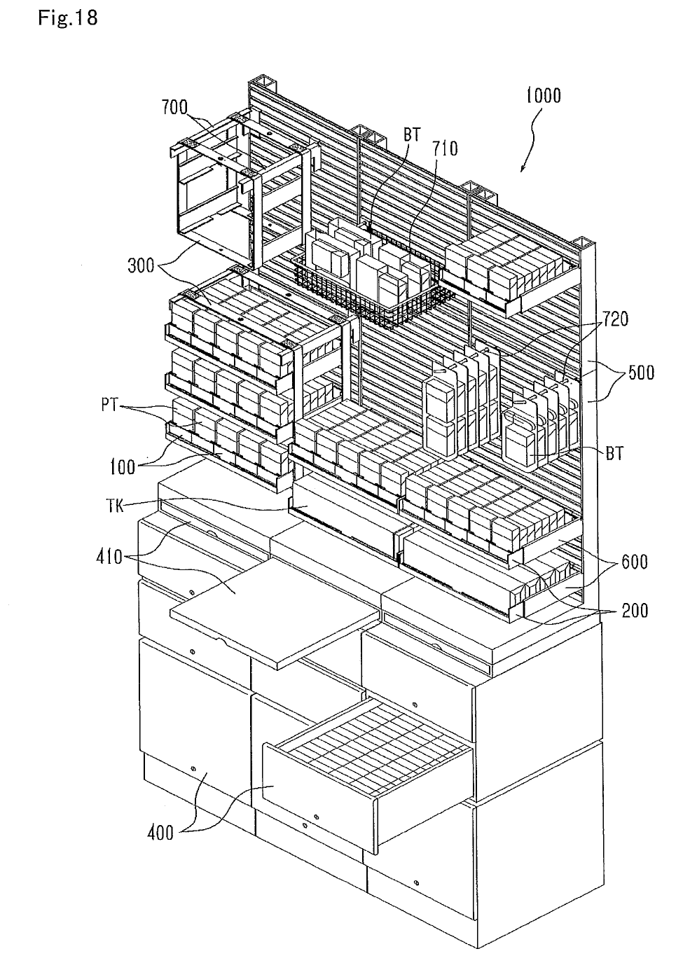

The cigarette display system 1000 may alternatively have a wall unit 500 as the unit component. In this case, as illustrated in FIG. 18, the cigarette display system 1000 may be built up using the wall unit 500, without using the frame units 300.

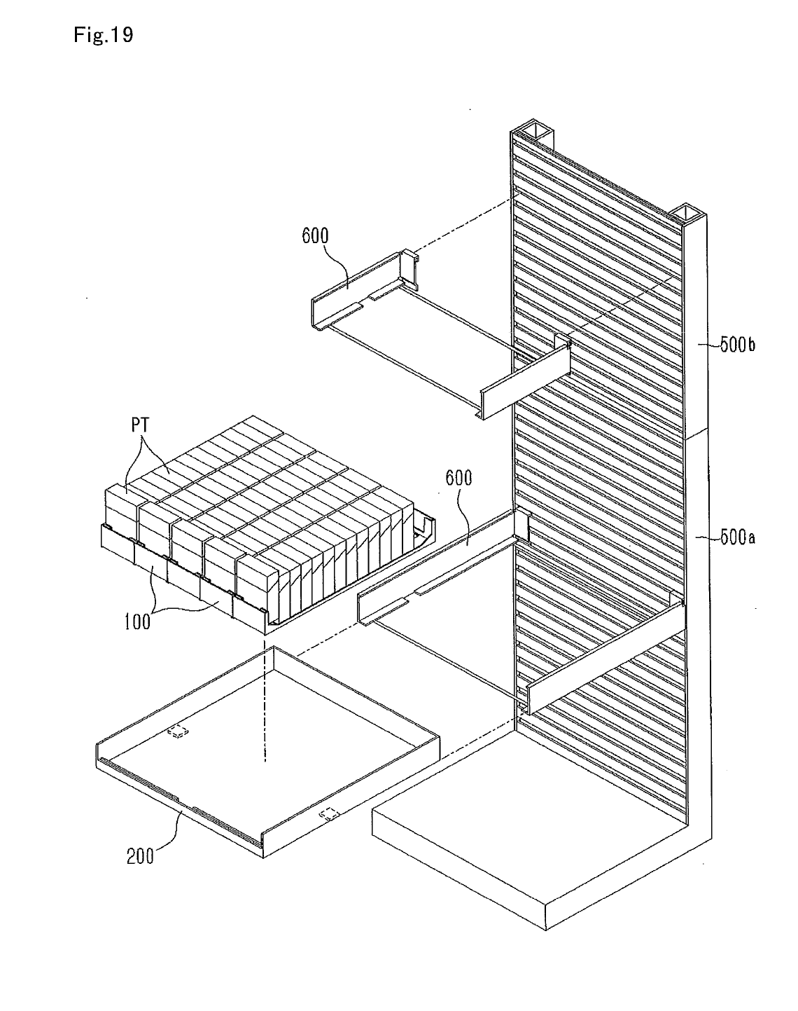

The wall unit 500 is configured by a base wall 500a and a panel wall 500b, as illustrated in FIG. 19. A plurality of panel walls 500b can be engaged in the vertical direction, and can be engaged with the upper end of the base wall 500a.

Thus, the wall unit 500 having a desired vertical dimension can be formed. The tray unit 200 may be attached to the wall unit 500 using a tray attachment 600.

The cigarette display system 1000 can be configured to have a desired vertical dimension by engaging a plurality of wall units 500 in the vertical direction, and also to have a desired lateral dimension by arranging the wall unit 500 in the lateral direction.

The tray attachments 600 may be attached at desired positions on the front faces of the wall units 500 arranged in the vertical and lateral directions as described in the above, so as to allow the tray attachments 600 to hold the tray units 200. Each tray unit 200 may directly accommodate the cigarette cartons TK, or may accommodate the cigarette packs TP making use of the magazine units 100.

Still further, as illustrated in FIG. 18, the wall unit 500 arranged in the vertical and lateral directions as described in the above may be installed on the top surfaces of the stocker units 400 arranged in the vertical and lateral directions, together with the table units 410 and so forth.

Still alternatively, a system built up with the wall units 500 and a system built up with the frame units 300 may be installed side-by-side to configure the cigarette display system 1000 (not illustrated).

The data processing device 800 may output a unit image modeled after the front geometry of the wall unit 500 on the above-described scale of reduction, to be displayed on the screen so as to allow the layout operation (not illustrated).

The embodiment in the above shows an exemplary case where the cigarette display system 1000 is built using structural components such as the frame units 300, and the unit images UP of the frame units 300 and so forth are output, by the displayed data processing device 800, to be displayed so as to allow the layout operation.

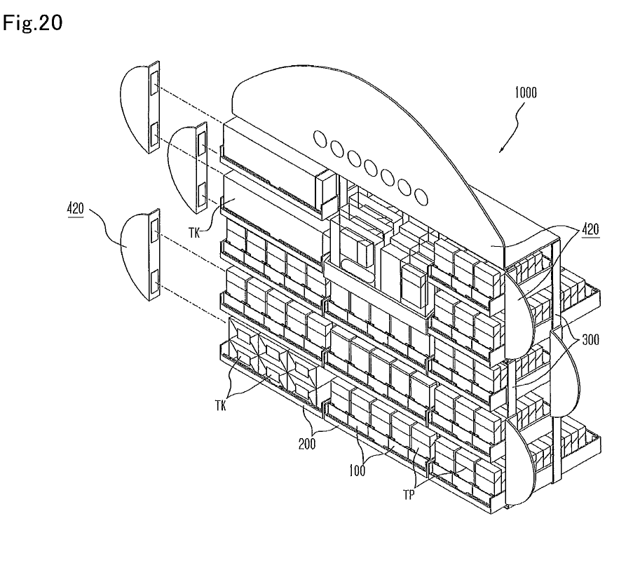

The cigarette display system 1000 may, however, have a plurality of types of advertising components 420 attached inside and outside the combined frame units 300, as illustrated in FIG. 20.

Therefore, the data processing device 800 may allow the layout operation, while outputting for display also advertising component data which contains advertising component images modeled after the front geometries of the advertising components 420 on the same scale of reduction with the unit images UP, set together with at least procurement costs on the basis of the individual types of the plurality of advertising components 420, and may calculate the total procurement cost corresponding to thus-arranged unit images UP and the advertising component images. In this case, the shop may examine configuration of the cigarette display system 1000, taking also the advertising components 420 into consideration.

The above-described advertising components 420 are offered by, for example, the suppliers of the cigarette packs TP and the cigarette display system 1000 to the shop with or without additional cost. If no additional cost is necessary, the procurement cost of the advertising components data may simply be set to “0”.

The above-described embodiment assumed the exemplary case where the unit data UD is simply set with purchase values as the procurement costs of the frame units 300 and so forth. Alternatively, the procurement costs may be surcharged with sending fee, assembly service fee and so forth of the frame units 300.

The above-described embodiment discussed the exemplary case where the unit images UP, having the same dimension but different in the display style of the cigarette packs TP and the cigarette cartons TK, are preliminarily registered to the data processing device 800, and are respectively output for display.

Alternatively, only a single unit image may be displayed for every outer dimension, and a schematic image of a display style inside the unit image can be displayed in a toggled manner corresponding to every input operation. In this case, the examination can be made by changing only the display style of the cigarette packs TP and the cigarette cartons TK without modifying the overall dimension and so forth of the arranged unit images.

The above-described embodiment discussed the exemplary case where the unit images UP are given by the schematic images of the display styles. The unit images UP may alternatively be given by photographic data of the actual frame units 300 and so forth, or may be given by the schematic images and photographic data toggled therebetween. In this case, more realistic finished images of the cigarette display system 1000 can be presented to the worker.

The above-described embodiment discussed the exemplary case where only a grid is displayed in the layout window LW. Alternatively, the data processing device may accept input of a photographic data of the shop taken by the worker using a digital camera or the like, and the photographic data may be displayed as a background of the layout window LW. In this case, the worker may be allowed to confirm a state of installation of the cigarette display system 1000 at the shop in a more real manner.

The above-described embodiment discussed the exemplary case where also the sales counter image CP may be arranged similarly to the unit images UP in the layout window LW by the layout operation. Alternatively, the sales counter image CP may be displayed while being toggled between the on/off states at a predetermined position in the layout window LW, corresponding to a predetermined input operation (not illustrated).

The above-described embodiment discusses the exemplary case where only the lateral dimension of the sales counter image CP may be adjustable. Alternatively, the vertical dimension of the sales counter image CP may be made adjustable, corresponding to an input operation and so forth of the vertical dimension of the actual sales counter.

The above-described embodiment discussed the exemplary case where the worker makes the layout operation of the desired unit images UP in the blank layout window LW. Alternatively, the data processing device may preliminarily store sample data of already-arranged unit images UP, and the sample data may be output for display in the layout window LW.

In this case, the worker at the shop may refer to the sample data recommended by the supplier, and may readily create a desired layout data by editing the sample data.

It has been made clear also that the degree of interest of the customer depends on the vertical position, with respect to the cigarette display system 1000 having a sufficient vertical dimension as described in the above. The layout window LW may, therefore, be output for display based on a color arrangement corresponding to the degree of interest of the customer.

In this case, for example, a layout operation such as arranging the unit image UPg of the simple fitting EF for accommodating the box packs BP at a position which attracts more interest of the customer, and arranging the unit image UPf of the frame unit 300 for accommodating the cigarette cartons TK at a position which attracts less interest of the customer, may be facilitated.

Moreover, the above-described embodiment discussed the exemplary case where the allowable vertical dimension of the cigarette display system 1000 is preliminarily denoted, and registered to the data processing device 800. Alternatively, the data processing device may further include a stature input unit accepting an input operation of the stature of the worker; a stature storage unit temporarily holding thus-entered stature; and an appropriate value calculating unit calculating an appropriate dimension in the vertical direction from the temporarily-held stature (not illustrated), and may output an non-conformity alarm when thus-calculated total of occupied dimensions exceeds the calculated appropriate dimension.

In this case, the worker may readily confirm whether the vertical dimension of the cigarette display system 1000 to be built is appropriate to his or her own stature. As a consequence, the cigarette display system 1000 may readily and exactly be prevented from being built up to have the vertical dimension causative of extremely poor handlability.

Alternatively, the data processing device having the stature input unit and the stature storage unit as described in the above may further have a person model adjusting unit which adjusts the scale of reduction of the person image PP output for display on the screen corresponding to the temporarily-held stature (not illustrated).

In this case, the worker may confirm, by intuition, whether the vertical dimension of the cigarette display system 1000 to be built is appropriate to his or her stature, based on a relative relation between the arranged unit images UP and the person image PP. Moreover, the person image PP having a plurality of types of stature may preliminarily be prepared.

The above-described embodiment assumed the exemplary case where the opaque person image PP may be arranged by the layout operation alongside, or in front of the arranged unit images UP. Alternatively, a semi-transparent person image PP may be output for display, and may be displayed while being toggled between the on/off states, typically by so-called right click on the mouse 845.

The above-described embodiment assumed the exemplary case where the data processing device 800 calculates and outputs for display the actual procurement cost in the real time and the occupied dimension of the cigarette display system 1000 depending on the layout operation of the unit images UP. Alternatively, the data processing device may calculate and output for display the procurement cost and the occupied dimension, when the worker arranges the unit images UP using the layout operation and then submits “enter” by a predetermined operation.

The operability by the worker may be improved for the case where the calculation and data output are sequentially executed in real time as described in the above, meanwhile the process load of the data processing device may be reduced for the case where they are executed corresponding to the input operation.

The above-described embodiment exemplified only that the price margin and the dimensional margin are calculated and output for display together with the total price and the total dimension, corresponding to the already-arranged unit data UD preliminarily set with the budget price and the planned dimension.

Alternatively, it may further be allowable to highlight any arrangeable unit images and to darken any unarrangeable unit images, corresponding to the price margin and the dimensional margin calculated as described in the above.

In this case, unit frames 300 additionally selectable without exceeding the budget price and the planned dimension may be confirmed at a glance, and thereby the layout may more readily be adjustable to the utmost possible limits of budget price and planned dimension.

The above-described embodiment assumes the exemplary case where the data processing device 800 outputs the data of procurement cost and occupied dimension of the actual cigarette display system 1000, corresponding to the layout operation of the unit images UP. Note that the frame units 300 of the cigarette display system 1000 described in the above are designated, on the basis of the individual types thereof, with the number of accommodation and the number of display of the fixed-size cigarette packs TP.

The data processing device may therefore store the unit data UD set with at least the number of display and the number of accommodation on the basis of the individual types of the frame units 300, and may output the total number of display and the total number of accommodation, corresponding to a plurality of arranged unit images UP (not illustrated). In this case, the worker may examine building-up of the cigarette display system 1000, taking utmost possible numbers of display and accommodation of the cigarette packs TP into consideration.

Furthermore, at least a part of the plurality of types of frame units 300 is designated with the number of arrangement of the fixed-size cigarette packs TP aligned in the depth-wise direction, as described in the above. While the number of the cigarette packs TP arranged in the vertical and lateral directions in the frame units 300 might be confirmed by the unit images UP, the number arranged in the depth-wise direction cannot be confirmed.

The data processing device may, therefore, store the unit images UP with a description of the number of arrangement (not illustrated). In this case, the number of cigarette packs TP arranged in the depth-wise direction of the frame units 300 may be confirmed by the unit images UP output for display.

The above-described embodiment assumes the exemplary case where the computer program 860, which allows the computer device at the shop to function as the data processing device 800, is supplied in a form of data storage medium such as the CD-ROM 852 from the supplier. Alternatively, this sort of computer program 860 may be supplied through so-called data communication typically through the Internet.

It can still also be allowable that a service which includes functions equivalent to those obtainable by the above-described data processing device 800 may be offered to a use terminal device such as the computer device at the shop by the data processing device such as a server at the supplier.

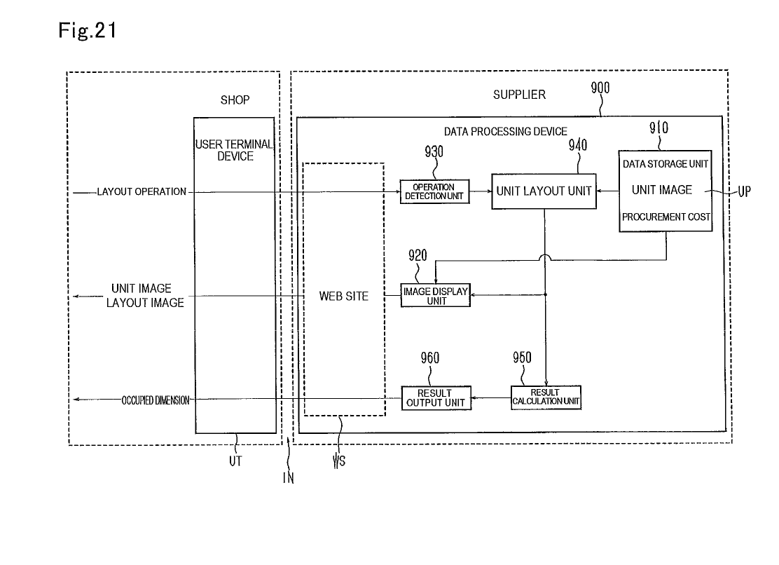

In this case, as illustrated in FIG. 21, a data processing device 900 at the supplier offers a web site WS used for assisting introduction of the above-described cigarette display system 1000, through the Internet IN to a user terminal device UT.

The data processing device 900 may have at least a data storage unit 910 which stores unit data which includes unit images UP modeled after the front geometries of the frame units 300 on a predetermined scale of reduction, set together with the occupied dimensions in the lateral and vertical directions and so forth, on the basis of the individual types of the plurality of the frame units 300; an image display unit 920 which outputs the unit images UP to be displayed on the screen of the web site WS browsed through the user terminal device UT; an operation detection unit 930 which detects a layout operation which is effected through the user terminal device UT on the unit images UP output for display; a unit layout unit 940 which arranges the unit images UP output for display on the web site WS, corresponding to a detected layout operation; a result calculation unit 950 which calculates a total of the occupied dimensions corresponding to the arranged unit images UP; and a result output unit 960 which outputs the calculated total of the occupied dimensions to be displayed on the web site WS.

In this case, the supplier who is going to offer the cigarette display system 1000 to the shop may offer functions for examining organization of the cigarette display system 1000 through the web site WS to the shop.

1. A data processing device used for assisting introduction of a unit system formed based on an arbitrary combination of a plurality of types of unit components vertically engaged and laterally arranged, comprising:
a display device that outputs various data to be displayed on a screen;
an input device that accepts various input operations;
a data storage unit that stores unit data including unit images modeled after front geometries of each of said plurality of types of unit components on a predetermined scale of reduction, set together with at least either of the lateral and vertical occupied dimensions thereof;
an image display unit that outputs said unit images to be displayed;
an operation detection unit that detects a layout operation which is effected through said input device on said unit images output for display on said screen;
a unit layout unit that arranges said unit images output for display on said screen, corresponding to the detected layout operation;
a result calculation unit that calculates a total of said occupied dimensions corresponding to the layout of said unit images; and
a result output unit that outputs said calculated total of said occupied dimensions to be displayed on said screen.

2. The data processing device as claimed in claim 1,
wherein said data storage unit stores said unit data which includes said unit images modeled after the front geometry of each of said plurality of types of unit components on a predetermined scale of reduction, set together with the occupied dimensions in the lateral direction.

3. The data processing device as claimed in claim 2, further comprising:
a left/right value input unit that accepts an input operation of a planned dimension in the lateral direction;
a left/right value storage unit that temporarily stores said input planned dimension; and
an alarm unit that outputs an alarm when the calculated total of said occupied dimensions exceeds said temporarily stored planned dimension.

4. The data processing device as claimed in claim 2,
wherein said data storage unit stores said unit data that further includes occupied dimensions in the vertical direction;
said result calculation unit further calculates a total of occupied dimensions in the vertical direction, corresponding to the layout of said unit images, and
said result output unit further outputs the calculated total of said occupied dimensions in the vertical direction to be displayed on said screen.

5. The data processing device as claimed in claim 4, further comprising:
a top/bottom value input unit that accepts an input operation of a planned dimension in the vertical direction;
a top/bottom value storage unit that temporarily stores said input planned dimension; and
an alarm unit that outputs an alarm when the calculated total of said occupied dimensions exceeds said temporarily stored planned dimension.

6. The data processing device as claimed in claim 5,
wherein said data storage unit further stores an allowable dimension in the vertical direction of said unit system, and the data processing device further comprises:
an alarm unit that outputs an alarm when the calculated total of said occupied dimensions exceeds said stored allowable dimension.

7. The data processing device as claimed in claim 5, further comprising:
a stature input unit that accepts an input of the stature of a worker;
a stature storage unit that temporarily stores said input stature;
an appropriate value calculating unit that calculates an appropriate dimension in the vertical direction based on said temporarily stored stature; and
an alarm unit that outputs an alarm when the calculated total of said occupied dimensions exceeds said calculated appropriate dimension.

8. The data processing device as claimed in claim 2,
wherein said data storage unit further stores a person image modeled after a front geometry of a person on the same scale of reduction with said unit images,
said image display unit further outputs said person image to be displayed on said screen,
said operation detection unit further detects a layout operation of said person image, and
said unit layout unit arranges said person image in front of, or alongside of said arranged unit images, corresponding to said detected layout operation.

9. The data processing device as claimed in claim 8,
wherein said data storage unit stores said person image, having the upper limb portions of which, modeled after the upper limbs of said person, freely rotatable around positions corresponded to the shoulder portions of said person, and
said operation detection unit further detects an input operation for rotating said upper limb portions of said person image output for display.

10. The data processing device as claimed in claim 8, further comprising:
a stature input unit that accepts an input of the stature of a worker;
a stature storage unit that temporarily stores said input stature; and
a person model adjusting unit that adjusts the scale of reduction on which said person image is output for display on said screen, corresponding to said temporarily stored stature.

11. The data processing device as claimed in claim 2,
wherein said plurality of types of unit components yield combinations of those engageable with each other and combinations of those unengageable with each other in the vertical direction,
said data storage unit stores said unit data that includes the combination of those engageable with each other in the vertical direction for each of said plurality of types of unit components,
said unit layout unit nullifies any layout operation relevant to the combination of said unit components unengageable with each other in the vertical direction, and the data processing device further comprises:
an alarm unit that outputs an alarm when a layout operation is effected on the combination of said unit images unengageable with each other in the vertical direction.

12. The data processing device as claimed in claim 2,
wherein said data storage unit stores said unit data that further includes procurement cost of each of said plurality of types of unit components,
said result calculation unit further calculates a total of said procurement costs corresponding to the layout of said unit images; and
said result output unit further outputs the calculated total of said procurement costs to be displayed on said screen.

13. The data processing device as claimed in claim 12, further comprising:
a budget input unit that accepts an input of a budget price;
a budget storage unit that temporarily stores said input budget price; and
an alarm unit that outputs an alarm when the calculated total of said procurement costs exceeds said temporarily stored budget price.

14. The data processing device as claimed in claim 2,
wherein said unit system further includes a plurality of types of advertising components disposed inside or outside of said combined unit components,
said data storage unit further stores advertising component data including advertising component images modeled after front geometries of each of said plurality of types of advertising components on the same scale of reduction with said unit images;
said image display unit further outputs said advertising component images to be displayed on said screen,
said operation detection unit further detects a layout operation of said advertising component images, and
said unit layout unit arranges said advertising component images inside or outside of said arranged unit images, corresponding to said detected layout operation.

15. The data processing device as claimed in claim 2,
wherein said unit system is a commodity display system installed over a sales counter so as to display commodities while being accommodated by each of said unit components,
said data storage unit further stores a sales counter image modeled after a front geometry of said sales counter on the same scale of reduction with said unit images,
said image display unit further outputs said sales counter image to be displayed on said screen, and
said unit layout unit arranges said unit images above said sales counter image, corresponding to the detected layout operation.

16. The data processing device as claimed in claim 2,
wherein said unit system is a commodity display system that displays commodities, that are at least partially fixed-size commodities, while being accommodated by each of said unit components,
each of said plurality of types of unit components is designated with the number of accommodation and the number of displays of said fixed-size commodities,
said data storage unit stores said unit data that further includes at least said number of displays respectively set for each of said plurality of types of unit components, and
said result output unit further outputs a total of said numbers of displays corresponding to said arranged plurality of unit images.

17. The data processing device as claimed in claim 16,
wherein said data storage unit stores said unit data which further includes said number of accommodation respectively set for each of said plurality of types of unit components, and
said result output unit further outputs a total of said numbers of accommodation corresponding to said arranged plurality of unit images.

18. The data processing device as claimed in claim 2,
wherein said unit system is a commodity display system that displays commodities, that are at least partially fixed-size commodities, while being accommodated by each of said unit components,
each of said plurality of types of unit components is designated with the style of display of said fixed-size commodities, and
said data storage unit stores said unit images modeled after said styles of display.

19. The data processing device as claimed in claim 18,
wherein said plurality of types of unit components is at least partially designated to have a plurality of types of display styles, and
said data storage unit stores a plurality of types of said unit images modeled after said plurality of types of display styles, respectively.

20. The data processing device as claimed in claim 19,
wherein said plurality of types of unit components is at least partially designated with the number of arrangement of said fixed-size commodities accommodated therein while being arranged in a row in the depth-wise direction, and
said data storage unit stores said unit images inscribed with said number of arrangement.

21. The data processing device as claimed in claim 1,
wherein said data storage unit stores said unit data that includes said unit images modeled after front geometries of each of said plurality of types of unit components on a predetermined scale of reduction, set together with the occupied dimensions in the vertical direction.

22. The data processing device as claimed in claim 21,
wherein said data storage unit further stores an allowable dimension in the vertical direction of said unit system, and the data processing device further comprises:
an alarm unit that outputs an alarm when the calculated total of said occupied dimensions exceeds said stored allowable dimension.

23. The data processing device as claimed in claims 21, further comprising:
a stature input unit that accepts an input of the stature of a worker;
a stature storage unit that temporarily stores said input stature;
an appropriate value calculating unit that calculates an appropriate dimension in the vertical direction based on said temporarily stored stature; and
an alarm unit that outputs an alarm when the calculated total of said occupied dimensions exceeds said calculated appropriate dimension.

24. The data processing device as claimed in claim 21, further comprising:
a top/bottom value input unit that accepts an input operation of a planned dimension in the vertical direction;
a top/bottom value storage unit that temporarily stores said input planned dimension; and
an alarm unit that outputs an alarm when the calculated total of said occupied dimensions exceeds said temporarily stored planned dimension.

25. The data processing device as claimed in claim 21,
wherein said data storage unit stores said unit data that further includes occupied dimensions in the lateral direction;
said result calculation unit further calculates a total of said occupied dimensions in the lateral direction, corresponding to the layout of said unit images, and
said result output unit further outputs said calculated total of said occupied dimensions in the lateral direction to be displayed on said screen.

26. The data processing device as claimed in claim 25, further comprising:
a left/light value input unit that accepts an input operation of a planned dimension in the lateral direction;
a left/right value storage unit that temporarily stores said input planned dimension; and
an alarm unit that outputs an alarm when the calculated total of said occupied dimensions exceeds said temporarily stored planned dimension.

27. The data processing device as claimed in claim 21,
wherein said data storage unit further stores a person image modeled after a front geometry of a person on the same scale of reduction with said unit images,
said image display unit further outputs said person image to be displayed on said screen,
said operation detection unit further detects a layout operation of said person image, and
said unit layout unit arranges said person image in front of, or alongside of said arranged unit images, corresponding to the detected layout operation.

28. The data processing device as claimed in claim 27,
wherein said data storage unit stores said person image, having the upper limb portions of which, modeled after the upper limbs of said person, freely rotatable around positions corresponded to the shoulder portions of said person, and
said operation detection unit further detects an input operation for rotating said upper limb portions of said person image output for display.

29. The data processing device as claimed in claim 27 further comprising:
a stature input unit that accepts an input of the stature of a worker;
a stature storage unit that temporarily stores said input stature; and
a person model adjusting unit that adjusts the scale of reduction on which said person image is output for display on said screen, corresponding to the said temporarily stored stature.

30. The data processing device as claimed in claim 21,
wherein said plurality of types of unit components yield combinations of those engageable with each other and combinations of those unengageable with each other in the vertical direction,
said data storage unit stores said unit data that further includes the combination of those engageable with each other in the vertical direction for each of said plurality of types of unit components,
said unit layout unit nullifies any layout operation relevant to the combination of said unit components unengageable with each other in the vertical direction, and the data processing device further comprises:
an alarm unit that outputs an alarm when a layout operation is effected on the combination of said unit images unengageable with each other in the vertical direction.

31. The data processing device as claimed in claim 21,
wherein said data storage unit stores said unit data that further includes procurement cost of each of said plurality of types of unit component,
said result calculation unit further calculates a total of said procurement costs corresponding to the layout of said unit images; and
said result output unit further outputs the calculated total of said procurement costs to be displayed on said screen

32. The data processing device as claimed in claim 31, further comprising:
a budget input unit that accepts an input of a budget price;
a budget storage unit that temporarily stores said input budget price; and
an alarm unit that outputs an alarm when the calculated total of said procurement costs exceeds said temporarily stored budget price.

33. The data processing device as claimed in claim 21,
wherein said unit system further includes a plurality of types of advertising components disposed inside or outside of said combined unit components,
said data storage unit further stores advertising component data including advertising component images modeled after front geometries of each of said plurality of types of advertising components on the same scale of reduction with said unit images;
said image display unit further outputs said advertising component images to be displayed on said screen,
said operation detection unit further detects a layout operation of said advertising component images, and
said unit layout unit arranges said advertising component images inside or outside of said arranged unit images, corresponding to said detected layout operation.

34. The data processing device as claimed in claim 21,
wherein said unit system is a commodity display system installed over a sales counter so as to display commodities while being accommodated by each of said unit components,
said data storage unit further stores a sales counter image modeled after a front geometry of said sales counter on the same scale of reduction with said unit images,
said image display unit further outputs said sales counter image to be displayed on said screen, and
said unit layout unit arranges said unit images above said sales counter image, corresponding to the detected layout operation.

35. The data processing device as claimed in claim 21,
wherein said unit system is a commodity display system that displays commodities, that are at least partially fixed-size commodities, while being accommodated by each of said unit components,
each of said plurality of types of unit components is designated with the number of accommodation and the number of displays of said fixed-size commodities,
said data storage unit stores said unit data that further includes at least said number of displays respectively set for each of said plurality of types of unit components, and
said result output unit further outputs a total of said numbers of displays corresponding to said arranged plurality of unit images.

36. The data processing device as claimed in claim 35,
wherein said data storage unit stores said unit data that further includes said number of accommodation respectively set for each of said plurality of types of unit components, and
said result output unit further outputs a total of said numbers of accommodation corresponding to said arranged plurality of unit images.

37. The data processing device as claimed in claim 21,
wherein said unit system is a commodity display system that displays commodities, that are at least partially fixed-size commodities, while being accommodated by each of said unit components,
each of said plurality of types of unit components is designated with the style of display of said fixed-size commodities, and
said data storage unit stores said unit images modeled after said styles of display.

38. The data processing device as claimed in claim 37,
wherein said plurality of types of unit components is at least partially designated to have a plurality of types of display styles, and
said data storage unit stores a plurality of types of said unit images modeled after said plurality of types of display styles, respectively.

39. The data processing device as claimed in claim 38,
wherein said plurality of types of unit components is at least partially designated with the number of arrangement of said fixed-size commodities accommodated therein while being arranged in a row in the depth-wise direction, and
said data storage unit stores said unit images inscribed with said number of arrangement.

40. The data processing device as claimed in claim 15,
wherein said commodities are configured by cigarette packs.

41. A data processing device as claimed in claim 1 which provides, through the Internet, a user terminal device with a web site used for assisting introduction of a unit system which includes a plurality of unit components vertically engaged and laterally arranged,
wherein said image display unit outputs said unit images to be displayed on the screen of said web site browsed through said user terminal device, and
said operation detection unit detects a layout operation which is effected through said user terminal device on said unit images output for display.

42. A method computer program for a data processing device including a display device that outputs various data to be displayed on a screen, and an input device that accepts various input operations, the method and is used for assisting introduction of a unit system formed based on an arbitrary combination of a plurality of types of unit components vertically engaged and laterally arranged, said method comprising:
unit storage processing of storing unit data including unit images modeled after front geometries of each of said plurality of types of unit components on a predetermined scale of reduction, set together with at least either of the lateral and vertical occupied dimensions thereof;
image display processing of outputting said unit images to be displayed on said screen;
operation detection processing of detecting a layout operation effected through said input device on said unit images output for display;
unit layout processing of arranging said unit images output for display on said screen, corresponding to the detected layout operation;
result calculation processing of calculating a total of said occupied dimensions corresponding to the layout of said unit images; and
result output processing of outputting said calculated total of said occupied dimensions to be displayed on said screen.

43. The method computer program as claimed in claim 42 that provides, through the Internet, a user terminal device with a web site used for assisting introduction of a unit system that includes a plurality of unit components vertically engaged and laterally arranged,
wherein said image display processing outputs said unit images to be displayed on the screen of said web site browsed through said user terminal device, and
said operation detection processing detects a layout operation which is effected through said user terminal device on said unit images output for display.

44. A computer-readable data storage medium for a data processing device including a display device that outputs various data to be displayed on a screen, and an input device that accepts various input operations, and is used for assisting introduction of a unit system formed based on an arbitrary combination of a plurality of types of unit components vertically engaged and laterally arranged, said computer-readable data storage medium storing a computer program executed by a processor that allows enables said data processing device to execute:
unit storage processing of storing unit data including unit images modeled after front geometries of each of said plurality of types of unit components on a predetermined scale of reduction, set together with at least either of the lateral and vertical occupied dimensions thereof;
image display processing of outputting said unit images to be displayed on said screen;
operation detection processing of detecting a layout operation effected through said input device on said unit images output for display;
unit layout processing of arranging said unit images output for display on said screen, corresponding to the detected layout operation;
result calculation processing of calculating a total of said occupied dimensions corresponding to the layout of said unit images; and
result output processing of outputting said calculated total of said occupied dimensions to be displayed on said screen.

45. The computer-readable data storage medium storing a computer program as claimed in claim 44, said computer program being provided for a data processing device that provides, through the Internet, a user terminal device with a web site used for assisting introduction of a unit system that includes a plurality of unit components vertically engaged and laterally arranged,
wherein said image display process outputs said unit images to be displayed on the screen of said web site browsed through said user terminal device, and
said operation detection process detects a layout operation that is effected through said user terminal device on said unit images output for display.
